(19) United States
(12) Patent Application Publication
(10) Pub. No.: US 2004/0071840 A1
(43) Pub. Date: Apr. 15, 2004

(54) Shelf-life extension system and method of centrally prepared retail-ready meat cuts utilizing a zero-oxygen packaging system

(76) Inventor: Gaurav Tewari, San Antonio, TX (US)

Correspondence Address: DR. GAURAV TEWARI, Apt. 1622, 12701 WEST AV., SAN ANTONIO, TX, 78216, US

(21) Appl. No.: 10/434,010

(22) Filed: May 8, 2003

Related U.S. Application Data
(60) Provisional application No. 60/379,668, filed on May 9, 2002.

(51) Int. Cl. A23G 1/00

(52) U.S. Cl. 426/133

(57) ABSTRACT

A packaging system and method of the same designed to extend the shelf-life of meat cuts comprising an activated oxygen scavenger and an absorbent pad, based on an iron chemical system, operatively positioned onto a tray. One or more trays is wrapped in a permeable film and is/are inserted into a master bag filled with a gas, namely nitrogen. The packaging system has a storage life of at least ten weeks and a display life of at least three days.

Specifically the method of extending shelf-life of meat includes where at least one meat cut is placed onto the tray having the oxygen scavenger and absorbent pad and the film is sealed over the tray. The master bag is filled with nitrogen gas and the tray(s) is/are introduced into the bag. Finally, the master bag is sealed into a closed position and placed in a cooling device for a period of time.

### PRIORITY DESIGNATION

This application claims the benefit of United States Provisional Application.

### TECHNICAL FIELD

The present invention relates to a packaging system and method of increasing the shelf-life of retail-ready meat cuts.

### BACKGROUND OF THE INVENTION

Meat production and packaging is well known in the industry. Traditionally, once a primal cut of meat has been made, it usually undergoes vacuum packaging in order to maintain its freshness and reduce the onset of outside bacterial contamination. These vacuum packed meat cuts are subsequently transported to meat distribution centers and/or supermarkets where the vacuum packaging is removed and the primal cuts are cut into smaller cuts. The smaller cuts are then repackaged or displayed in a case for sale. In a relatively short period of time, the meat cuts lose the red color and start to brown or otherwise become discolored thereby losing its aesthetic, healthy appeal causing lost revenues to occur.

Specifically, the meat cuts lose their healthy color due to metmyoglobin (aka browning of meat). Here, metmyoglobin is formed due to oxidation of de-oxymyoglobin where such a reaction is irreversible. Under the reduced oxygen condition, the rate of the metmyoglobin formation is extremely high. Since meat muscle has a limited enzymatic activity known as metmyoglobin reducing activity (MRA) which bring metmyoglobin back to deoxymyoglobin, this conversion takes several days resulting in transient meat discoloration of retail-ready meat cuts. This transient discoloration is detrimental for centralized meat operations. Furthermore, the MRA is extremely limited and once consumed, cannot be rejuvenated.

Nevertheless, centralized packaging of retail meat cuts is gaining in popularity in the food industry due to its economies and the potential to maintain quality, enhance safety and extend the shelf-life of fresh meat. Requirements to optimize shelf-life of centrally prepared retail-ready meat cuts are slightly different from those needed to extend shelf-life of fresh chilled meat for periods up to fifteen weeks. Deterioration of chilled meats primarily takes place at the cut or uncut muscle surface. In long term storage, primal cuts are placed in an atmosphere saturated with carbon dioxide, CO₂ (100%) which contains very low residual oxygen (O₂) and these are held at −1.5±0.5° C. At the end of required storage, meat is removed and fabricated into retail or food service cuts. New fresh surfaces are created in the process, revitalizing the appearance of the meat cuts; and when the new surfaces of the meat cuts are prepared for retail display the normal expectation is a further four days of shelf-life. Depending on the variability of the meat species, the shelf-life is usually limited by development of undesirable organoleptic changes, where defects in color are usually independent of the microbial presence. The latter has a lactic acid bacterial population, which maximizes under storage conditions at levels about 10⁸ cfu/cm² well before the shelf-life expiration.

However, with centralized distribution of retail ready fresh meat, circumstances are different. The wholesale storage period following initial packaging of the retail cuts is in the range of 20-30 days and prepared products must withstand the rigor of retail display for up to two days thereafter without further manipulation of the contents of the package. Retail packages are simply moved from their storage container (usually a unit or over wrap containing a modified atmosphere) to retail display where desirable meat color develops upon exposure to air. The present commercial centralized meat operations only provide one to two weeks of shelf-life. Whereas, in North America, total shelf-life of several weeks is desired because of distant markets and intent of North American meat industry to export to distant countries. Hence, the goal is to extend the shelf-life of retail-ready meat cuts.

One goal of extending the shelf-life of meat has been depicted in the process for pre-packing fresh meat as seen in U.S. Pat. No. 4,683,139. The '139 patent describes a process where the meat is treated with an aqueous solution containing three active components, namely phosphate compounds, a reducing agent and a sequestering agent; and then packaging the meat in a controlled gaseous atmosphere containing from about 20 to 80 percent carbon dioxide and from about 2 to 30 percent oxygen, with the balance being nitrogen. Specifically, the process includes (1) placing at least one pork chop on each of a plurality of semi-rigid trays; (2) placing a gaseous mixture over and around the chops on each of the trays; (3) sealing the trays with a gas permeable film; (4) placing a plurality of the trays on a thermoformed tray; and (5) covering and sealing the thermoformed tray with a gas impermeable film. However, the '130 patent concentrates on the centralized pre-packing of fresh meats at the meat packing plant prior to shipment to the point of storage or retail sale. Further, the '139 patent fails to include 100% nitrogen gas filling a master bag before the placement of the tray.

Other examples of inventions desiring to extend the shelf-life of food products are U.S. Pat. Nos. 5,527,105 and 5,705,215 issued to Riach, Jr. The '105 and '215 patents provide for a magnetic method for extending the shelf-life of food products wherein magnetic strips, matting formed from the strips and pads having magnetic north sides and magnetic south sides. Here, the negative magnetic north sides of the magnetic strips or pads are arranged to impinge on the fresh food products stored in a low-temperature environment. However, the '105 and '215 patents achieve a wetter condition thereby establishing a longer shelf-life condition for foods which are stored in a combined environment to include a north magnetic field and a selected low temperature.

Another example of a shelf-life extender for food use is depicted in U.S. Pat. No. 5,985,303 issued to Okada in 1999. The '303 shelf-life extender incorporates an isothiocyanic acid compound being supported on a matrix, where the compound is packaged in synthetic resin film or nonwoven fabric. However, the '303 patent concentrates on acidic chemical compounds and gelling agents as opposed to integrating a zero oxygen packaging system as described by the present invention.

A couple of years ago, U.S. Pat. No. 6,153,241 described a method and a package for extending the shelf-life of a food. Specifically, the method of achieving an extended shelf life for a food includes enclosing the food in a discrete container having a first and a second container position, treating the food in the discrete container with heat in a treatment chamber while the container maintains the first container position and raising the container to the second container position under which the container is distributed, sold or used. However, contrary to the present invention, the '241 patent describes a method of heat treating a pumpable food carried out in a treatment chamber.

Present commercial centralized meat operations employ master packaging in which three or more trays, each containing retail-ready meat cuts, are placed in a gas-impermeable master bag. However, residual oxygen may be present inside the packages due to the entrapment of oxygen during controlled atmosphere packaging (CAP). Specifically, the residual oxygen may be present due to any one of the following factors: (1) insufficient oxygen evacuation; (2) insufficient flushing times during CAP-machine operations; (3) use of an improper ration of meat-mass to package atmosphere resulting in dead space in the master bag; (4) oxygen entrapment in the retail trays themselves, in absorbent pads or under the meat cut; (5) oxygen ingress through seams of a film used to overwrap a master pack; or (6) film defects. Since some of these factors are inevitable in commercial meat packaging operations, the plain use of master packaging has found limited application in commercial centralized meat operations. Therefore, a system is needed to reduce the oxygen concentration in a relatively short period of time in order to restore the metmyoglobin reducing activity.

In view of the above deficiencies associated with the abovementioned shelf-life extenders and methods, the present invention has been developed to alleviate these drawbacks and provide further benefits to the meat distribution centers, supermarkets and the consumer. These enhancement and benefits are described in greater detail hereinbelow.

### SUMMARY OF THE INVENTION

The present invention in its several disclosed embodiments alleviates the drawbacks described above with respect to traditional meat packaging and incorporates several additionally beneficial features. The process of packaging meat, namely retail-ready meat, is known in the prior art. When fresh meat is exposed to oxygen, two effects normally occur. First, bacteria begins to grow and subsequently the fresh meat color disappears. By eliminating exposing the meat to oxygen, the chances of reducing bacteria and extending the fresh meat color improve dramatically. As a result, the present invention effectively removes oxygen very rapidly from a sealed package thereby increasing the shelf-life of the meat to about 12 weeks or more.

A packaging system was designed to extend the shelf-life of centrally prepared retail-ready meat cuts. When the metmyoglobin reducing activity of the meat-muscle is restored, then an extremely long shelf-life of retail-ready meat cuts is obtained. Here, a retail-ready meat cut is placed in a tray having an activated oxygen scavenger (based upon an iron chemical system) and an absorbent pad. Several of these trays were placed in a master bag that is filled with 100% nitrogen and sealed. Several combinations of placing scavengers (based upon iron chemical systems) and optimization of the oxygen scavenging capacity in each tray were attempted. The tray containing optimum oxygen scavenging capacity (≧600 mL) that can result in 0.6-2 h half-life for oxygen in the master bag (depending upon the initial oxygen concentration and meat-type), is the one desired for centrally prepared retail-ready meat cuts. Such packaging system under 100% nitrogen atmosphere resulted in a ten week storage life for centrally prepared meat cuts, such as beef tender loin steaks, with a subsequent display life of three days.

Thus, the use of an activated oxygen scavenger and an absorbent pad inside a master bag having 100% nitrogen introduced therein provides a significant increase in profits by reducing spoilage. By reducing the partial pressure of oxygen to zero ppm in the master bags, the growth of the aerobic spoilage and pathogenic microorganisms is inhibited thereby extending the storage and display life of retail-ready fresh meat packages. Additionally, this process preserves the vivid, bright cherry red color of red meats, whereby longer shelf life and better looking meat products translate into higher sales and higher profits. Moreover, the master package will reduce purge due to temperature changes and will actually enhance the natural aging process producing more flavorful and tender cuts of fresh meat.

Another advantage of the present invention is a retailer is capable of unpackaging a days' supply of fresh meat cuts at a time. The master package is protected from oxygen exposure until the seal is released and the individual packages are placed in the retail case. In essence, the shelf life clock does not begin ticking until the fresh meat is placed in the retail case. For central packaging operations, by utilizing the master packages, the shrinking of meat cuts due to handling, transportation and temperature fluctuations is greatly reduced to virtually zero shrinkage.

A further advantage of the present invention is the zero-oxygen system stops the formation of metmyoglobin, the agent that causes fresh meat to become discolored. By not allowing the metmyoglobins to form, the metmyoglobin reducing activity of the meat muscle is retained. Since the oxygen concentration in the master bag is zero ppm, metmyoglobin cannot form and the discoloration process never takes place. Further, under the zero-oxygen system, only lactic acid and other slow growing anaerobic bacteria will grow; and the growth of faster growing aerobic bacteria causing rapid spoilage would be restricted.

Another advantage of the present invention is it increases the shelf-life in the retail case by five to seven additional days, depending upon the type of meat cut. Since the present packaging system preserves the enzymatic activities of meat-muscle that maintains the bright cherry red color of each meat cut, the retail display life of the meat is extended dramatically.

### DESCRIPTION OF THE DRAWINGS

The invention will now be described in greater detail in the following way of example only and with reference to the attached drawings, in which:

FIG. 1 is a x-y graph depicting the influence of oxygen partial pressure on three chemical states of myoglobin.

FIG. 1A is a table displaying the half-life of oxygen in bags containing scavengers based upon enzymes and iron chemical systems in an air or nitrogen atmosphere as described in Example 1.

FIG. 1 B is a table showing constants of first order kinetics equation for various scavengers.

FIG. 2A is a table describing treatments for beef steaks and pork chops as described in Example 2.

FIG. 2B is a table depicting oxygen concentration in master packs containing beef and pork stored at 2° C. in 100% nitrogen atmosphere over the course of seven days as described in Example 2.

FIG. 2C is a table displaying mean color, surface discoloration and retail appearance scores and standard errors for pork chops and beef steaks after various treatments.

FIG. 2D is a table depicting mean values of the chemical states of myoglobin (% met-, % deoxy-, and % oxy-myoglobin) and standard errors of difference for pork chops and beef steaks after various treatments.

FIG. 2E is an x-y graph depicting a discoloration score given to bags undergoing various treatments as described in Example 2.

FIG. 2F is an x-y graph depicting a retail appearance score given to bags undergoing various treatments as described in Example 2.

FIG. 2G is an x-y graph showing different treatments given a discoloration score during retail display times as described in Example 2.

FIG. 2H is an x-y graph illustrating different treatments given a retail appearance score during retail display times as described in Example 2.

FIG. 2I is an x-y graph showing different treatments having a certain percentages of metmyoglobin during retail display times as described in Example 2.

FIG. 3A is an x-y graph depicting a control and two experimental types given a discoloration score within storage intervals as described in Example 3.

FIG. 3B is an x-y graph illustrating the control and two experimental types given a retail appearance score within storage intervals as described in Example 3.

FIG. 3C is an x-y graph illustrating the control and two experimental types having a percentage of metmyoglobin taken during storage intervals as described in Example 3.

FIG. 4A is an x-y graph showing different weeks receiving color scores during retail display times as described in Example 4.

FIG. 4B is an x-y graph showing different weeks receiving discoloration scores during retail display times as described in Example 4.

FIG. 4C is an x-y graph showing different weeks receiving retail appearance scores during retail display times as described in Example 4.

FIG. 4D is an x-y graph showing different weeks receiving off odor intensity scores during a course of days of retail display as described in Example 4.

FIG. 4E is an x-y graph showing different weeks receiving odor acceptability scores during a course of days of retail display as described in Example 4.

FIG. 4F is an x-y graph depicting different weeks showing a microbial count during a course of days of retail display as described in Example 4.

FIG. 5A is an x-y graph depicting a microbial plate count for meats, namely lamb chops stored on foam trays over a period of time.

FIG. 5B is an x-y graph illustrating microbial plate count for meats, namely lamb chops stored on plastic trays over a period of time.

FIG. 5C is an x-y graph detailing odor acceptability of meat, namely lamb chops, based on the amount of time the chops are displayed.

FIG. 5D is an x-y graph showing scores of off-odor intensity based on the amount of time the chops are displayed.

FIG. 5E is an x-y graph depicting scores of retail appearance of meat, namely lamb chops based on time of retail display in plastic trays.

FIG. 5F is an x-y graph depicting scores of retail appearance of meat, namely lamb chops based on time of retail display in foam trays.

FIG. 5G is an x-y graph illustrating surface discoloration of meat, namely lamb chops in plastic trays based on time of retail display.

FIG. 5H is an x-y graph detailing surface discoloration of meat, namely lamb chops, in foam trays based on time of retail display.

FIG. 5I is an x-y graph showing color scores of meat, namely lamb chops in plastic trays, based on time of retail display.

FIG. 5J is an x-y graph showing color scores of meat, namely lamb chops in foam trays, based on time of retail display.

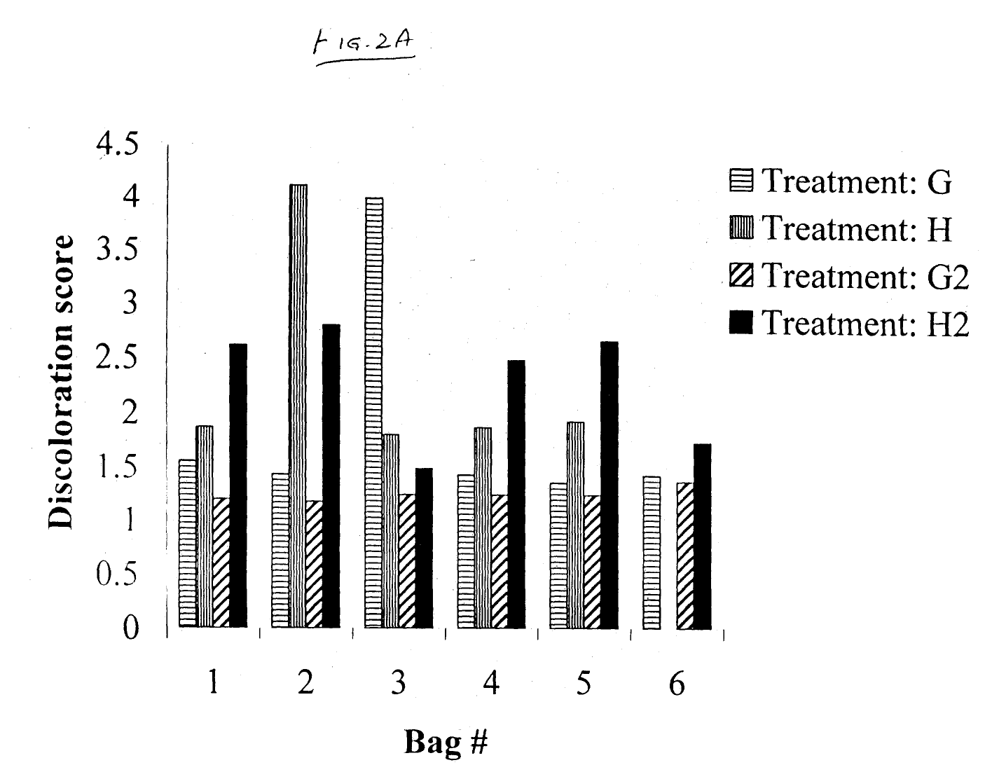

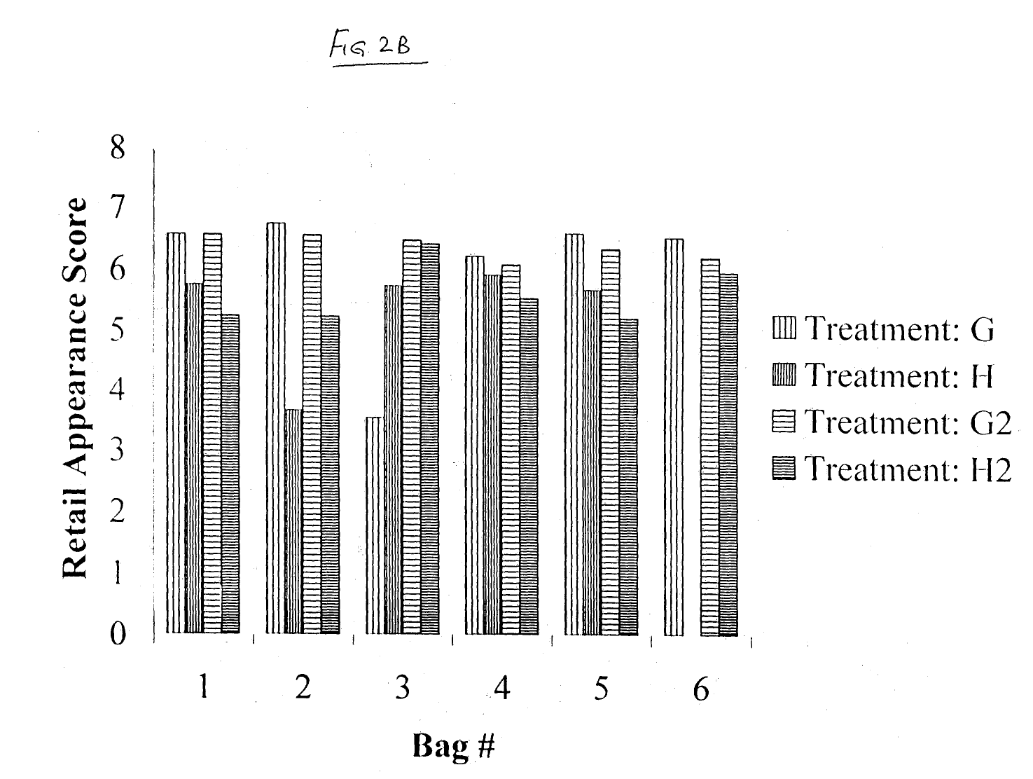

### DETAILED DESCRIPTION OF THE PRESENT INVENTION

As required, detailed embodiments of the present invention are disclosed herein; however, it is to be understood that the disclosed embodiment(s) are merely exemplary of the invention that may be embodied in various and alternative forms. Specific structural and functional details disclosed herein are not to be interpreted as limiting, but merely as a basis for the claims and as a representative basis for teaching one skilled in the art to variously employ the present invention. Further, the particular materials and amounts thereof, as well as other conditions and details, recited in these examples should not be used to unduly limit this invention.

Example 1 depicts the first phase of the present invention involving a detailed oxygen absorption study of oxygen scavengers based upon an iron chemical system and enzymatic activity. The iron chemical system based scavengers are dependent upon the chemical reaction of ferrous iron to ferric oxide or ferric hydroxide. Specifically, Example 1 concludes the oxygen scavengers which were modified based upon the iron chemical system have the potential for reducing the oxygen concentration to 0 ppm within a few hours of master packaging, provided an appropriate selection of oxygen scavengers is combined with appropriate placement in the package. Two factors restricting the activity of the oxygen scavengers are sub-zero temperatures such as −1.5° C. and a low oxygen concentration. For example, the rate of the iron chemical reaction is greatly reduced at subzero temperatures. Additionally, low oxygen concentrations prevent random movement of oxygen molecules due to diffusion, and result in longer oxygen absorption rates. Therefore, the activation of a custom-designed oxygen scavenger of an appropriate capacity is capable of yielding short half-life of oxygen, i.e. a high rate of oxygen absorption. Furthermore, the packaging film, preferably having a high oxygen permeability, acts as an oxygen barrier under sub-zero temperatures and low oxygen concentrations. Thus, the first phase concentrates on the placement of oxygen scavengers positioned inside the tray and being surrounded by the packaging film.

In the second phase as illustrated in Example 2, the scavengers were interiorly placed within the trays containing meat muscles. Here, the meat muscles had poor color stability since the packaging films covering the trays (seen in Example 1) act as oxygen barriers under sub-zero temperatures and low oxygen concentrations. During the second phase, several experiments concentrated on the effect of varying the oxygen-absorbing capacities on the display life. Further, the need for knowing the initial concentration of oxygen in the package, calculating the needed half life of oxygen in the package and subsequently designing the oxygen scavenger required to obtain the desired half life of oxygen.

Example 3 depicts the third phase of the present invention whereby preventing transient discoloration of the meat cuts, namely the retail-ready meat cuts. Lastly, the fourth phase as shown in Example 4 shows that the restoration of metmyoglobin reducing activity will result in extending the shelf-life of retail ready meat cuts. For example, the shelf-life of the retail-ready beef tender loin cuts was ten weeks with a display life of three days after each weekly storage differing from the conventional one to two weeks with a display life of one and half days.

### EXAMPLE 1

### Oxygen Absorption Kinetics of Enzymatic and Iron Chemical Systems Based Oxygen Scavengers

The current uses of O₂ scavengers generally involve packs in which the atmosphere contains some substantial fraction of O₂, if not air, at the time of pack sealing and the inhibition of chemical reactions or proliferation of microorganisms that proceed relatively slowly. Consequently, commercial O₂ scavengers are designed to remove a specified amount of O₂ from a relative high O₂ atmosphere over periods of a day or more. The rate of O₂ absorption has then not been a principal concern in the design of commercial O₂ scavengers. However, there are applications such as centralized meat operations where the rate of O₂ absorption is of prime importance.

The O₂ absorption rates of O₂ scavengers vary with the natures of their reactants and other materials used in their construction. Rates of absorption may also be affected by factors such as temperature and the compositions of the atmospheres to which they are exposed. Therefore, the objective of this study was to design an oxygen scavenger for centralized meat operation after studying the O₂ absorption kinetics of O₂ scavengers based upon enzymes and iron chemical systems.

Materials and Methods

O₂ Scavengers

The O₂ scavengers based upon iron chemical systems and enzymes were manufactured. Before the experiments, applying moisture activated scavengers based upon iron chemical systems. Since scavengers based upon iron chemical system may for carboxylic acid in the presence of C O₂ atmosphere, hence, only nitrogen atmosphere should be used to obtain maximum oxygen absorption rates from these scavengers.

Absorption of O₂ by Scavengers

O₂ scavengers were placed in gas impermeable bags composed of a laminate of polyester, oriented nylon, and an EVOH/EVA co extrusion with an O₂ transmission rate of 0.55 mL m²24 h⁴atm⁴ at 23° C., 70% r.h. Bags containing scavengers were either emptied of air by flattening each bag around the scavengers it contained, or were evacuated then filled with a known volume of N₂ or CO₂, using a controlled atmosphere packaging (CAP) machine, before being sealed. Then, a quantity of air was injected into each bag using a gas-tight syringe inserted through a stick-on septum (Modem Controls, Inc., Minneapolis, Minn., USA). Immediately after the injection of air, the puncture-point was sealed using a hot iron. Each filled bag was stored at room or a constant temperature. Samples (8 mL) of the atmosphere in each bag were obtained every hour for 8 h by means of a gas tight syringe inserted through a stick-on septum. If no substantial O₂ absorption was noticed within 8 h, samples were taken after every 12 h for up to 96 h. Immediately after each sampling, the O₂ concentration in the sample was determined using an O₂ analyzer (Mocon MS0750, Modem Controls, Inc., Minneapolis, Minn., USA) with a zirconium oxide sensor, and the puncture-point was then sealed using a hot iron. Residual air in the emptied bag was measured as the volume of water displaced by the emptied bag, and was used in the calculation.

To examine the effects of temperature and initial O₂ concentrations on O₂ absorption rates, scavengers were placed in bags after the scavengers, in their original sealed package, had been held overnight at the temperature at which O₂ absorption was to be measured. For each of the two scavengers at each temperature, six bags were prepared. Three of the bags were emptied of air, and sealed, and then 240 mL of air was injected into each. The other three were each filled with 4.5 L of N₂ before being sealed, and then 15 mL of air was injected into each. For each of the two scavenger types based upon scavenging mechanism, two sets of six bags were prepared, with one set being stored at each of the temperatures 25, 12, 2 or −1.5° C.

To characterize O₂ absorption when O₂ scavengers were placed inside over wrapped retail trays within master packs, a 216×133×25 mm (L×W×H) retail tray over wrapped with a film of O₂ transmission rate of 8000 mL m²24 h⁴atm⁴ at 23° C., 70% r.h., containing scavengers, based upon iron chemical system, was placed in each of the six bags. A 5 mm hole was made at one corner of the over wrapped film to allow free exchange of atmospheres during gas flushing. three bags were emptied of air and sealed, and then 240 mL of air was injected into each. The other three bags were each filled with 4.5 L of N₂ to which 15 mL of air was added by injection.

Data Analysis

The half-life of O₂ in a pack atmosphere was calculated as the time required for the O₂ concentration in the pack atmosphere to be reduced to half the initial value. The half-life was calculated from the volumes of O₂ at successive time intervals during the storage of the pack. In calculating the volumes of O₂ absorbed from each atmosphere of air by the scavenger, the initial volume of air was taken to be the 240 mL added to the pack plus the measured volume of residual air. The volume of O₂ in a pack at the end of any period was calculated as the volume of atmosphere at the end of the period multiplied by the concentration of O₂ in the atmosphere at that time. The volume of atmosphere at the beginning of each period was taken to be the volume of atmosphere at the beginning of the previous period less the volume of the atmosphere removed as a sample at the end of the period and the volume of O₂ calculated to have been absorbed during the previous period.

The volume of O₂ absorbed during a period was calculated as the volume of atmosphere at the start of the previous period multiplied by the concentration of O₂ in the atmosphere at the beginning of the period less the volume of atmosphere at the start of the period multiplied by the concentration of O₂ at the end of the period. In calculating the volumes of O₂ remained in the pack in atmospheres of N₂ or CO₂ to which air was added, the volumes of the atmosphere removed during sampling and the volumes of O₂ absorbed during a period were neglected.

To determine the order of reaction, plots were prepared of the natural logs (logₘ) and the reciprocals of the volumes of O₂ remaining in the pack atmosphere against time. If the logₘ plot approximated a straight line, the reaction was regarded as first order. If the reciprocal plot approximated a straight line, the reaction was regarded as second order. Rate-constants were calculated using the following equations:

for first-order reactions; and

for second-order reactions,

where, [A]ₜ=amount of reactant A at time t (h),

k=the rate-constant (h⁴), and

[A]ₒ=the initial amount of reactant.

Frequency factors and activation energies were calculated from the Arrhenius Equation of the form:

where,

A=frequency factor (frequency of collisions),

Eₐ=activation energy (J mol⁴),

R=universal gas constant (8.314 J mol⁴ K⁴), and

T=temperature (K).

Results

Using scavengers based upon iron chemical system in bags containing air, the O₂ half-life was four times longer at −1.5° C. than at 25° C., but with a N₂ atmosphere, the O₂ half-life at −1.5° C. was only double that at 25° C. (Table 1a). The O₂ half-life in bags containing air and scavengers based upon enzymes was seven times longer at −1.5° C. than at 25° C., but was only two and a half times longer at −1.5° C. than at 25° C. with a N₂ atmosphere (Table 1a).

The O₂ absorption reaction was first order for all the O₂ scavengers (Table 1b).

Discussion

The O₂ concentrations affected the O₂ half-lives substantially for any scavenger type resulting in longer O₂ half-lives for the low initial O₂ concentration of 500 ppm in N₂ atmospheres than for the high initial O₂ concentration of 200 000 ppm in air at the same temperature. Scavengers based upon iron chemical systems have shorter O₂ half-lives than the scavengers based upon enzymes. The kinetic data of the present study showed that the O₂ absorption reaction was first-order at both high (20%) and low (500 ppm) initial O₂ concentrations and included O₂ concentration as a limiting factor. At high initial O₂ concentration, other factors, such as the scavenger surface area and environment, may also affect the O₂ absorption rates. However, at low initial O₂ concentrations a diffusion-phenomenon, which is a derivative of O₂ concentration, was the dominant influence and resulted in low O₂ absorption. A threshold O₂ concentration existed where there was a dramatic decrease in O₂ absorption rate and O₂ concentration became the primary limiting factor for the O₂ absorption rate. Consequently, different rate-constants were observed for the same O₂ absorption curve at the same temperature, depending upon initial O₂ concentration. Therefore, the overall O₂ absorption curve produced by the scavenger was bi-phasic.

The effect of the positioning of scavengers within packs was also substantial which suggests that despite its high O₂ permeability, the barrier film acted as an O₂ barrier at low O₂ concentrations. Additionally its barrier effect may increase with decreasing temperature. consequently, the size of the hole in the lidding film is likely the limiting factor for O₂ absorption when retail trays were placed in a bag.

Due to significant variation in O₂ absorption rates of O₂ scavengers based upon iron chemical systems and enzymes, appropriate selection of O₂ scavengers is of importance in situations where high O₂ absorption is initially required. For centralized meat operations, scavengers based upon iron chemical system should be employed. Also, oxygen absorbing capacity of these oxygen scavengers should be ≧600 mL. However, due to significant positioning effects, they should be placed either inside the retail trays containing O₂ sensitive products or inside the retail trays as well as in the surrounding gas-impermeable bags.

### EXAMPLE 2

### Testing of Different Master Packaging Options for Centralized Meat Operations

Materials and Methods

Oxygen (O₂) Scavengers

O₂ scavengers, based on iron-chemical systems, were used. These scavengers require moisture (>70% relative humidity) for activation and operating in air of N₂ atmospheres but not in C O₂ atmospheres.

Master Packaging and Storage of Steaks and Chops

Experiment 1: Ten fresh beef tenderloins (psoas major, PM) and twenty fresh pork loins (longissimus dorsi, LD) from animals slaughtered 24 h previously, at local commercial beef-and pork-abattoirs, respectively, were obtained. The meat cuts were vacuum-packaged and stored at 2° C for 14 to 21 days and then used in the experiments. A total of 39 steaks and 39 pork chops were prepared from the stored samples. Each steak or pork chop was placed on a solid polystyrene tray with dimensions of 216×133×25 mm (L×W×H) containing eight O₂ scavengers and a single absorbent pad. Each retail tray was lidded with a shrinkable film with an O₂ transmission rate of 8000 mL m²24 h⁴atm⁴ at 23° C., 70% r.h. using commercial glue. Two 3 mm holes were burned through the film in opposite corners of each tray using a soldering iron to allow free exchange of atmospheres during gas flushing. Three retail trays were placed on a plastic cafeteria tray, which as then placed in a 595×447 mm (L×W) bi-metalized, plastic laminate bag with an O₂ transmission rate of 0.55 mLm² 24 h⁴atm⁴ at 230 V smf 70% r.h. The bag was then evacuated, filled with 2.5 L of N₂, and heat sealed using a controlled atmosphere packaging (CAP) machine. Twelve master packs each containing three steaks or three pork chops, were prepared and randomly allocated within species to different treatments including treatments where scavengers were placed either in retail trays or in master package (Table 2a). Three retail trays containing steaks or pork chops were not stored and served as controls.

Master-packaged steaks and pork chops were stored at 2° for one week. The O₂ concentration in each master pack was then measured. The retail trays were then placed on retail display and evaluated for visual characteristics by a 4-member trained sensory panel

Experiment 2: Twenty-five beef rib-eyes (longissimus thoracis, LT) from animals slaughtered 24 h previously, were obtained from a local commercial beef-abattoir and were vacuum-packaged and stored at 2° C. Following storage for 3 weeks, steaks (96, 2 cm thick) were placed in solid polyethylene trays with dimensions of 216×133×25 mm containing eight O₂ scavengers underneath an absorbent pad. Retail trays were lidded with a shrinkable permeable film and were prepared as in Experiment 1. Four retail trays were placed on a cafeteria tray, which in turn was placed into a paster pack. The master-pack bags were evacuated, filled with 3.25 L of N₂, and heat-sealed using the CAP machine. Six such packs were prepared containing one of four treatment combinations (G,H; Table 2a) and G2 and H2 (not given in Table 2a), which were over-wrapped instead of lidded. Please note treatments, G2 and H2, differ from other treatments (G and H), by having retail trays over-wrapped instead of lidded. The master packs were stored and evaluated using procedures similar to those used in Experiment 1.

Experiment 3: Twenty-five Beef tenderloins (psoas major, PM) from animals slaughtered 24 h previously, were obtained from a local commercial beef-abattoir. Steaks (2 cm thick) were placed in 216×133×25 mm-solid polyethylene trays containing O₂ scavengers with 200 mL (S2), 400 mL (S4), 600 mL (S6), or 800 mL (S8) underneath an absorbent pad. Each retail tray was over-wrapped with a highly O₂ permeable and shrinkable film as previously described. Containing the same treatment combination (S2, S4, S6, or S8), four retail trays were placed in a master pack, which was evacuated, filled with 4.5 L of N₂, and heat-sealed using the CAP machine. Three retail trays served as un-stored controls.

Following one week of storage at −1.5° C., the O₂ concentration in each master pack was measured as previously described. All master bags were removed and the retail trays were placed on retail display and evaluated for visual characteristics daily for four days.

Display and Evaluation of Retail Trays

All retail trays were placed at the center of the display shelf. displayed steaks (PM or LT) and pork chops (LD) were evaluated for color, extent of discoloration, and retail appearance 30-45 min after master pack opening by a 4-5 member trained sensory panel. The details of the eight-point descriptive scale for the color of beef, the six-point descriptive scale for the color of pork, the seven-point descriptive scale for discoloration of both beef and pork, and the seven-point hedonic scale for retail appearance for both beef and pork are given in Table 3. Reflectance spectra from the meat surfaces were obtained to estimate the proportions of metmyoglobin, deoxymyoglobin, and oxymyoglobin.

Estimation of the Oxidative Status of Myoglobin

Each retail tray containing a steak or a chop was evaluated by reflectance spectrophotometry (Macbeth Color eye 1500/Plus, Kollmorgen Corp., Newburg, N.Y., USA), at three anatomical locations on each cut. Proportions of the different chemical states of myoglobin (deoxy-, met-, and oxy-) were estimated using standard procedures, by converting the readings (R) to K/S values [K is the absorption coefficient and S is the scattering coefficient, determined at selected wavelengths using the formula: K/S=(1−R)²/2R]. Ratios of wavelengths used for calculations are: K/S 474÷K/S 525 for % deoxymyoglobin, K/S 572÷K/S 525 for % metmyoglobin, and K/S 610÷K/S 525 for oxymyoglobin.

Statistical Analysis

The influences of different treatments on factors influencing meat color were compared statistically for significant differences (p<0.05) using Analysis of Variance (proc ANOVA and LSD means) in SAS (SAS Institute Inc., Cary, N.C., USA).

Results

Experiment 1

Oxygen Concentration

The O₂ concentration in every fifth bag at initial packaging was 150-200 ppm. After being stored for one week at 2° C.? the O₂ concentration in most bags with O₂ scavengers was 0 ppm, except for bags with treatments H, G, and G1 with beef (Table 2b). Bags without O₂ scavengers contained small amounts of O₂, occasionally up to 1150 ppm.

Visual Properties

Pork color scores in all treatments ranged from 2.4 to 3.3, and would be considered normal except in treatment D1, where the chops were slightly pale (Table 2c). Chops in all treatments could be considered to be without discoloration, except in treatments A and B, where the chops were slightly discolored. Chops in all treatments were rated desirable to extremely desirable except in treatments A, B, and D1. Chops in treatment A were rated slightly undesirable and chops in treatments B and D1 were rated slightly desirable. Beef steaks in all treatments were perceived to be bright cherry red to moderately dark red, except in treatments E and G1, where color scores were reduced due to complete discoloration of one or more steaks. Steaks in all treatments without O₂ scavengers either inside the retail tray or in the master pack were moderately discolored. Steaks in treatments H and G1 were also moderately discolored, undoubtedly as a result of O₂ ingress through the pack. Steaks in all treatments with O₂ scavengers inside the retail tray were perceived to be at least slightly desirable, except in treatments H and G1, due to extensive discoloration as a result of apparent O₂ ingress. Comparison of retail appearance scores for beef steaks stored with and without O₂ scavengers indicates the necessity of including O₂ scavengers in master packaged, display ready meat cuts, stored in controlled atmospheres. Comparison of treatments D and F with D1 and F1 for beef clearly demonstrates the O₂ scavengers should be positioned inside the retail tray.

Chemical States of Myoglobin

Pork chops in all treatments previously stored with O₂ scavengers had 62.0% or more oxymyoglobinand essentially 0.0% metmyoglobin when displayed in air, except in treatments G and H1 (Table 2d). Chops in treatment G had 2.1% and chops in treatment H1 had 6.8% metmyoglobin. Beef steaks in treatments containing O₂ scavengers had >90.0% oxymyoglobin, and <2.5% metmyoglobin, except in treatment H and G1. Steaks in treatment H had 78.5% oxymyoglobin and 7.8% metmyoglobin; and steaks in treatment G1 had 58.9% oxymyoglobin and 37.3% metmyoglobin, presumably as a result of O₂ ingress into the package. These data confirm the visual data and the requirement for O₂ scavengers inside the retail tray when master packing display-ready meat cuts in controlled atmospheres.

Experiment 2

Oxygen Concentration

The initial O₂ concentration in every fifth bag was ˜120 ppm. After one week of storage, the O₂ concentration in all bags was 0 ppm, except for one bag (Bag 2, treatment H) which contained 2650-ppm O₂ and was a “leaker.” consequently it was eliminated from further evaluation.

Visual and Reflectance Properties

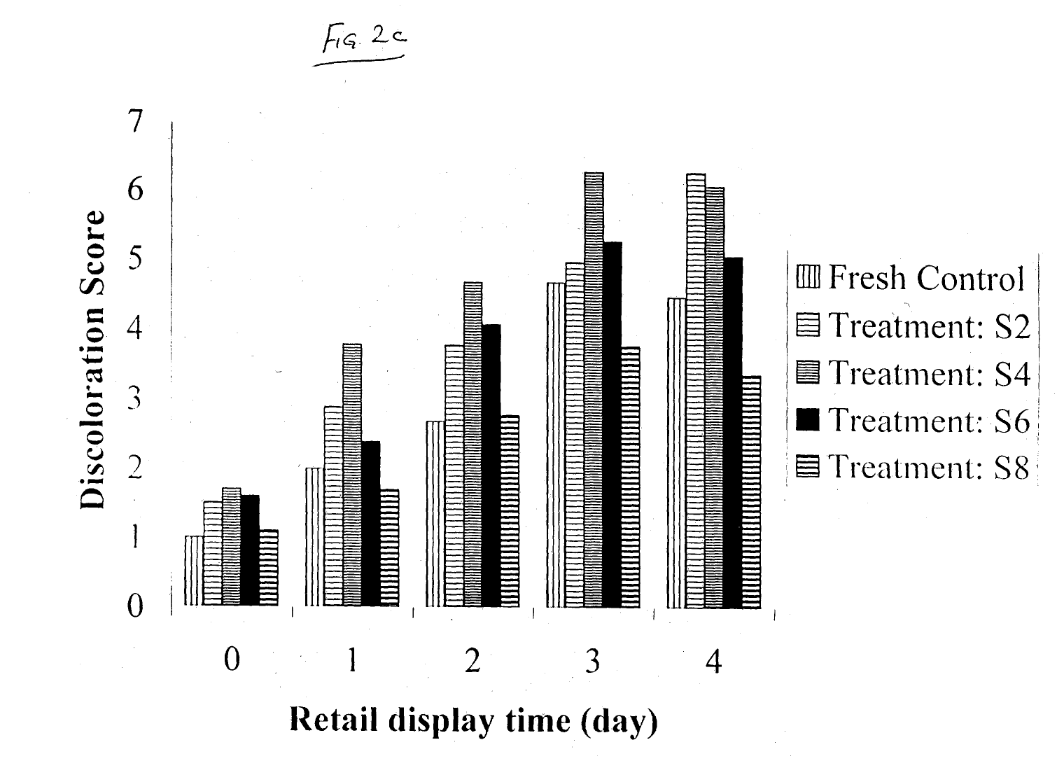

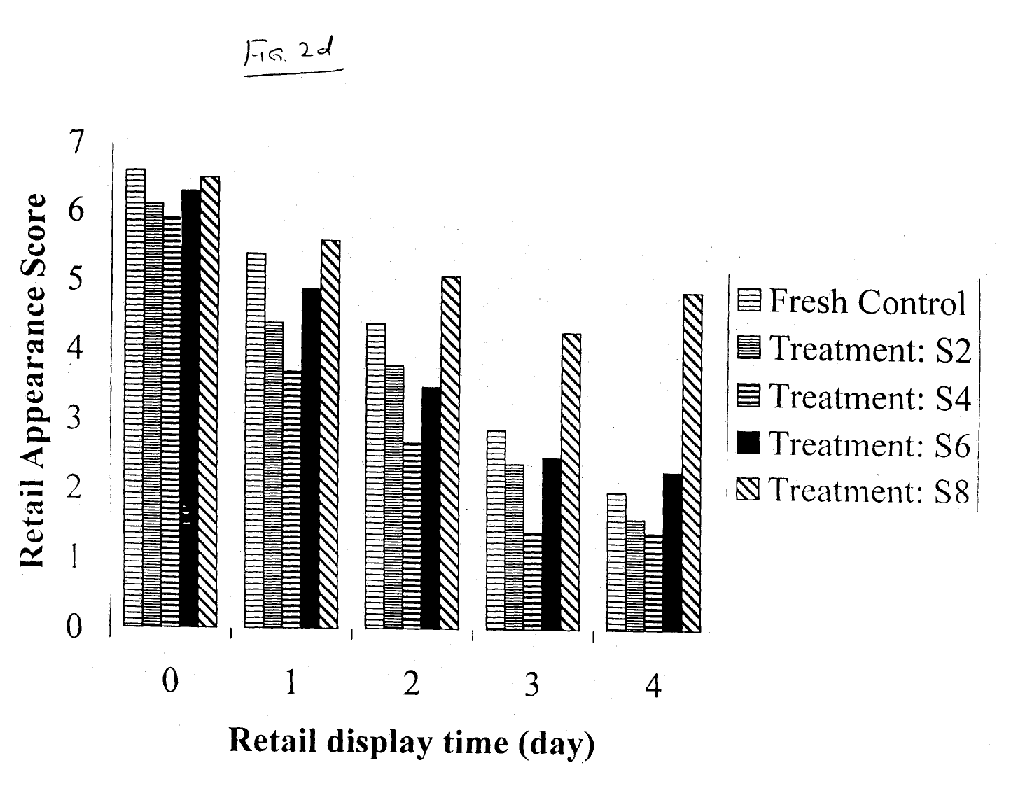

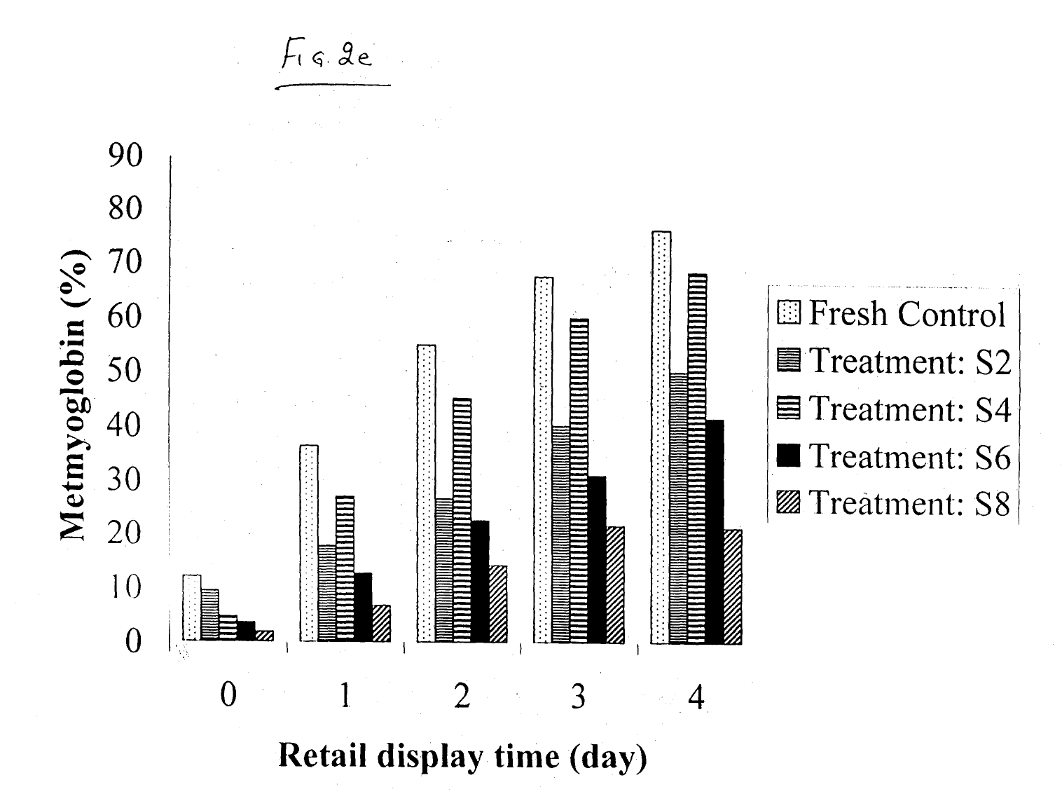

Although significant (p<0.05) differences existed between treatments in visual color ratings, all steaks were perceived to be bright cherry red and no differences of practical importance existed. Retail trays containing grids resulted in steaks with greater amounts of surface discoloration. However, no differences in surface discoloration attributable to lidding or over-wrapping were detected (FIG. 2a). Consequently, steaks in retail trays containing grids were rated less desirable in retail appearance (p<0.05). However, the magnitudes of these differences in retail appearance were approximately 0.8 of a panel unit making them of only marginal practical importance (Fg. 2b). Steaks in over-wrapped trays containing a grid had the highest proportions of oxymyoglobin and the lowest proportions of metmyoglobin (p<0.05). Despite this finding, the visual data clearly indicates inclusion of a grid in the tray is not so productive, and the overall data clearly demonstrates similar advantages for either lidding or over-wrapping the trays. Consequently, the most feasible retail packaging system for use with controlled atmosphere, master packaging is the over-wrapped tray containing O₂ scavengers underneath an absorbent pad.

Experiment 3

Oxygen Concentration

The O₂ concentration at packaging was approximately 80 ppm. After 7 days of storage at −1.5° C., the O₂ concentration in all bags was 0 ppm.

Visual and Reflectance Properties

Steaks in retail trays containing having O₂ scavengers with absorbing capacity of <600 mL, were more discolored than the un-stored controls at all display intervals, but discolored essentially the same rate as the un-stored controls (FIG. 2c). Steaks in retail trays containing O₂ scavengers with 800 mL of absorbing capacity also discolored at essentially the same rate as the un-stored controls, but did not discolor as extensively. Un-stored controls deteriorated rapidly in retail appearance and had a retail case-life of 2.5 days (FIG. 2d). Steaks stored with ≦six O₂ scavengers also deteriorated rapidly in retail appearance and had shorter retail-case lives than un-stored controls. Steaks stored with O₂ scavengers having absorbing capacity of >600 mL deteriorated more slowly in retail appearance and had retail-case lives in excess of 4 days (FIG. 2d). The rate of metmyoglobin and oxymyogloin (% oxymyoglobin=100−% metmyoglobin) formation during retail display (FIG. 2e) clearly demonstrates the advantage of using O₂ scavengers and indicates a minimum requirement for O₂ scavengers with absorbing capacity >600 mL, resulting in an O₂ half-life of 0.6-0.7 h in the pack atmosphere, where the O₂ concentration could otherwise remain ≦500 ppm at any time during storage.

Discussion

At low temperatures pork color is stable at several hundred ppm of O₂. The present study confirmed this finding. beef, especially PM, discolors even at very low O₂ concentrations, which is also evident from the results of the present study. The present results clearly demonstrate O₂ scavengers are essential to prevent and/or reduce discoloration in master-packaged meats. The use of O₂ scavengers in master packing of pork should provide protection to complement the intrinsic ability of pork muscle tissue to resist oxidative discoloration and may provide increased display life.

The use of O₂ scavengers reduced O₂ concentrations to 0 ppm in most treatments in the present study. The appropriate absorbing capacity of O₂ scavengers to be used appears to be >600 mL based upon present results.

Steaks and chops used in the present study were vacuum-packaged and stored for two to three weeks at 2° C. before master packaging, which would have lowered their metmyoglobin-reducing capacity, and therefore presented a worst-case challenge for centralized packaging operations. Therefore, greater storage ability should be expected with fresh, un-stored beef or pork. Although pork can probably be master packaged without O₂ scavengers or using any treatment-combination with O₂ scavengers, the presence of O₂ scavengers inside the retail tray appears to be imperative when master packaging beef. Treatments G, G2, H, and H2 were selected as retail packaging systems, which may be commercially adaptable. Additional replicates of each of these treatments were evaluated in part II of the present study to determine the importance of a grid inside the retail tray and to obtain a comparison of lidded and over-wrapped retail trays. Results indicated a grid was not required and there was little difference between lidded and over-wrapped trays. With CAP master-packages, selection of an appropriate retail packaging system should include an assessment of the number of O₂ scavengers required in each retail tray to minimize residual O₂ concentrations.

High O₂-permeable film over-wrap has been shown to act as an O₂ barrier at low O₂ concentration. consequently, two isolated systems affect the O₂ concentration in the overall package-atmosphere of master packs. The probability of having O₂ entrapped inside the retail tray is high due to the absorbent pad and space between over-wrap and edges of the tray.

The amount of O₂ absorbing capacity in each retail tray will also dictate the retail display life of meat cuts. Steaks packaged with higher absorbing capacity, i.e., with a high absorbing capacity, O₂ scavengers, tend to have more retail display life than those packaged with low absorbing capacity O₂ scavengers as the present study demonstrated longer retail display life for steaks packaged with O₂ scavengers of absorbing capacity >600 mL than with O₂ scavengers of low capacity. The higher the absorbing capacity, the shorter the O₂ half-life is in the pack atmosphere, resulting in faster removal of residual O₂ and this in turn prevents transient discoloration. With prevention of transient discoloration, the limited metmyoglobin reducing capacity of the muscle is preserved. This activity further delays development of discoloration during retail display and yields acceptable retail appearance even after four days of retail display, as shown in the present study.

The present study demonstrated little importance for placing meat cuts on a grid and little advantage for lidding retail-trays. However, O₂ scavengers based upon iron chemical system with oxygen absorbing capacity ≧600 mL must be placed inside the retail trays, for an O₂ concentration of ≦500 ppm in the pack atmosphere and for a master pack of the size 595×447 mm. Such number of O₂ scavengers can vary provided they can provide a O₂ half-life 0.3-0.4 h in the master pack. Another combination, depending upon the color stability of meat cuts, could be placing some oxygen scavengers in the master pack (outside the retail tray) and only a few in the retail tray. However, the commercial system that can deliver a total storage and shelf life of retail-ready eat cuts should have clear plastic tray with oxygen scavengers underneath the absorbent pad, and meat cut placed on top of the absorbent pad.

### EXAMPLE 3

### Prevention of Transient Discoloration of Retail-Ready Beef Cuts

Centrally-prepared retail beef cuts stored in controlled atmospheres containing nearly 100% carbon dioxide © O₂) or nitrogen (N₂) which may have small amounts of O₂ are susceptible to the formation of metmyoglobin, due to the presence of the residual O₂. if the O₂ concentration is not excessive, the meat will absorb the residual O₂ and any metmyoglobin formed will be reduced to deoxymyoglobin as a result of metmyoglobin reducing activity (MRA) within the muscle tissue. In packaged fresh beef 2-4 d are required for reduction of metmyoglobin to deoxymyoglobin. When stored meat is removed from the controlled atmosphere, it blooms to the desirable, bright, red color associated with freshly cut meat, but this will not occur if a substantial amount of metmyoglobin is present. The MRA of muscle tissue is limited and once exhausted cannot convert any metmyoglobin formed back to myoglobin. This results in inevitable transient discoloration problem.

Transient discoloration of meat is not a major concern when the product is in storage, transit, or both for long periods. However, such discoloration is highly undesirable when commercial conditions require periodic rapid distribution and display of centrally packaged meat. Consequently, premature temporary discoloration limits the advantages of centrally packaged retail ready meat cuts using O₂-depleted master packaging technology. such discoloration is also dependent upon the specific muscle packaged since tissues vary in their capacity to withstand “low” O₂ concentrations (<500 ppm). Centrally prepared beefsteaks and ground beefpackaged under controlled atmospheres, were shown to be susceptible to very low O₂ concentrations. Beef muscles with high color stability (LD) are least susceptible to metmyoglobin formation if atmospheres contained <600 ppm of O₂ at temperatures <0° C.; however, beef with poor color stability (PM) was highly susceptible to metmyoglobin formation even at very low O₂ concentrations and sub-zero temperatures.

The objective of this study was to determine whether O₂ absorben technology might be used in conjunction with CAP to prevent inevitable transient discoloration of PM beef.

Materials and Methods

Oxygen Scavengers

O₂ scavengers, based on iron chemical systems, were used in the study.

Master Packaging, Storage, and Sampling of Steaks

Twenty fresh beef tenderloins (psoas major, PM) from animals slaughtered with 24 h, were obtained from a local beef-packing plant. Four 2 cm. thick steaks were prepared from each tenderloin and were randomly distributed. Each steak was placed on an absorben pad of dimensions 152×114 mm in a 216×133×25 mm solid polystyrene tray. Eight O₂ scavengers were placed underneath the absorben pad. Each retail tray was over-wrapped with a shrinkable film having an O₂ transmission rate of 8000 mL/(m² 24 h) at 23° C. and 70% r.h. After sealing, the film was shrunk to the tray using a hot-air gun. Two 3-mm holes were made in the film at the corners of the tray to allow free exchange of atmospheres during gas flushing. Four such retail trays were placed in a 595×447 mm bimetalized, plastic laminate pouch. The master packs were evacuated, filled with 4.5 L N₂, and sealed using a CAP machine. Eight such master packs were prepared. Similarly, eight master packs, each having four retail trays containing two another type of O₂ scavengers underneath the absorbent pads; and an additional eight master packs, each containing four retail trays with no O₂ scavengers (controls), were prepared. Each pack was labeled accordingly.

The master-packaged steaks were stored at 1±0.5° C. On day 0, four retail trays served as fresh controls and were kept for visual evaluation in the retail-display case and to obtain reflectance spectra of the steak surfaces. Three master packs (one having one type and another one having another type of O₂ scavengers, and one having no O₂ scavenger), were opened at 1 d intervals for 8 d and placed in a retail display case. The O₂ concentration in each pack was measured immediately before being opened.

Display and Sampling of Retail Trays

All retail trays were placed in the center of the display shelf of a horizontal, fan-assisted retail display case.

The PM steaks on display were examined for color, discoloration, and retail appearance at 30-45 min after opening of the master-packs, and reflectance spectra of the steak surfaces were obtained to estimate metmyoglobin, deoxymyoglobin, and oxymyoglobin content.

Visual Assessment of Master-Packaged Steaks

A five-member trained panel was used for the subjective evaluation of the steaks. Surface discoloration was evaluated using a seven-point descriptive scale: 1=0% (none), 2=1-10%, 3=11-25%, 4=26-50%, 5=51-75%, 6=76-99%, 7=100%. Retail appearance was assessed using a seven-point hedonic scale: 1=extremely undesirable, 2=undesirable, 3=slightly undesirable, 4=neither desirable nor undesirable, 5=slightly desirable, 6=desirable, 7=extremely desirable.

Estimation of Myoglobin States

The average reflectance spectrum was obtained from three locations of the steak covered with a shrinkable film using a reflectance spectrophotometer. Reflectance values (R) of the different myoglobin oxidation states were estimated at specified wavelengths, and converted to K/S values (K is the absorption coefficient and S is the scattering coefficient). The K/S values are used for quantifying the proportion of deoxy-met-, and oxy-myoglobin, and are calculated using selected wavelengths (474, 525, 575, and 610 nm) for fresh meat color. The ratios and wavelengths used for the calculations were: K/S 474÷K/S 525 for percent deoxymyoglobin, K/S 575÷K/S 525 for percent metmyoglobin, and K/S 610÷K/S 525 for percent oxymyoglobin.

Statistical Analysis

The effects of treatment differences (control and both types of O₂ scavengers) were examined statistically using analysis of variance (proc ANOVA, SAS Institute, Inc., Cary, N.C.) at an a level of 0.05. Only the main effects were analyzed.

Results

Visual Assessment of Steaks

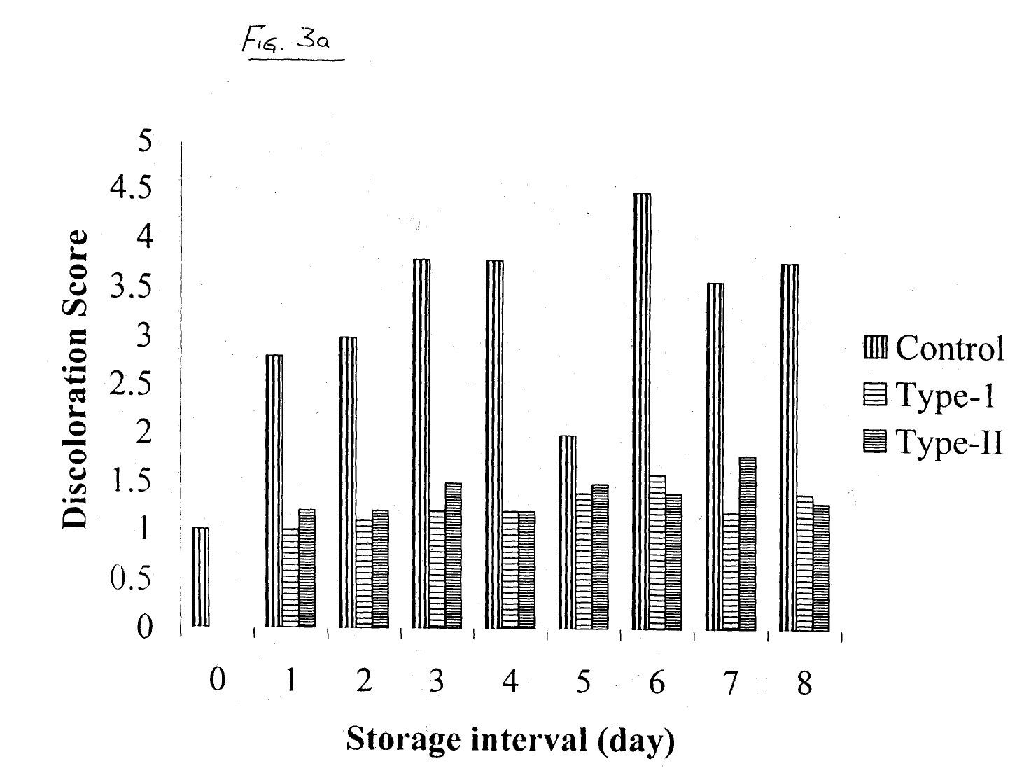

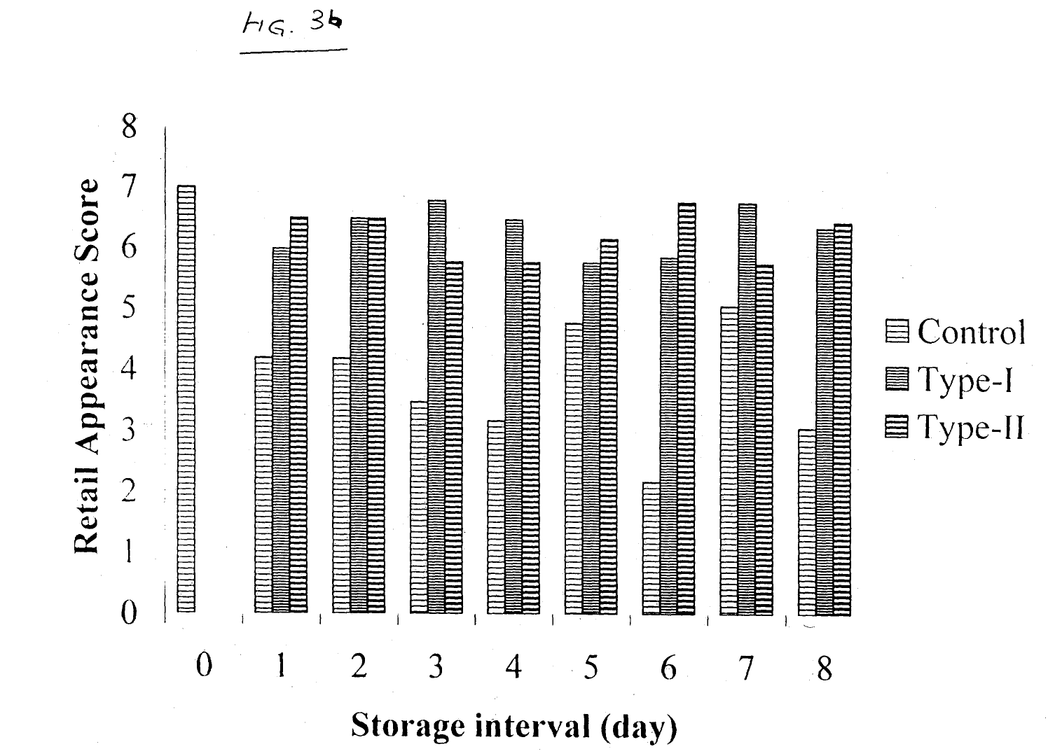

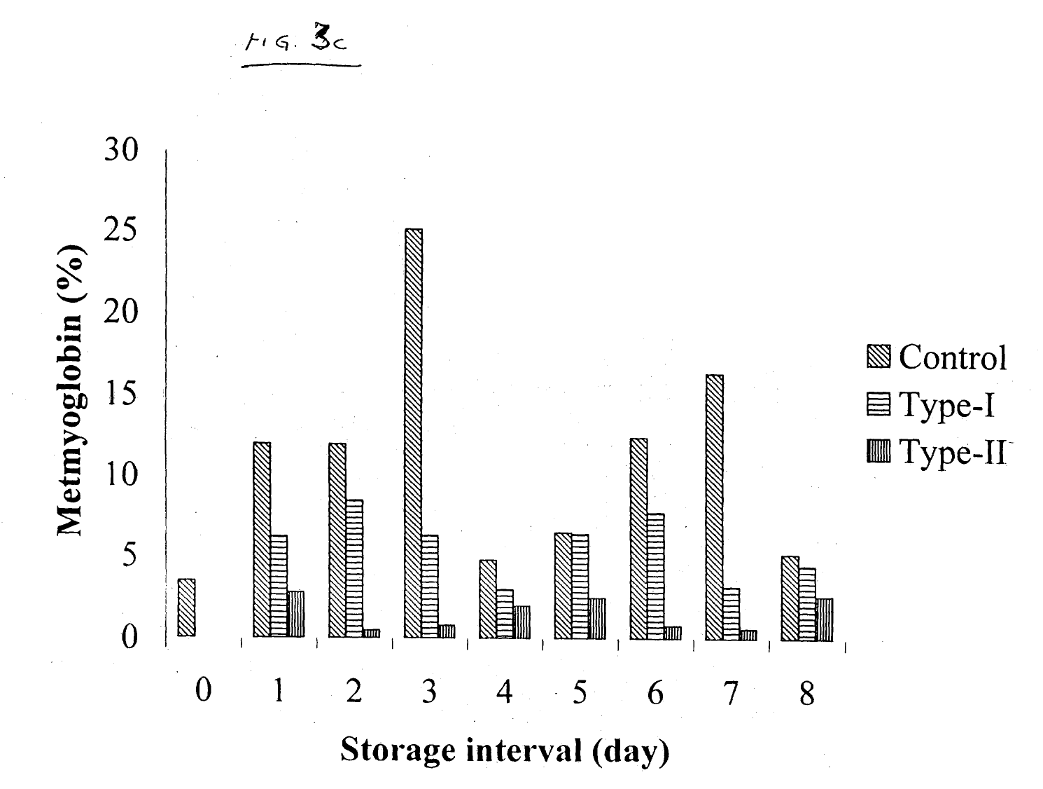

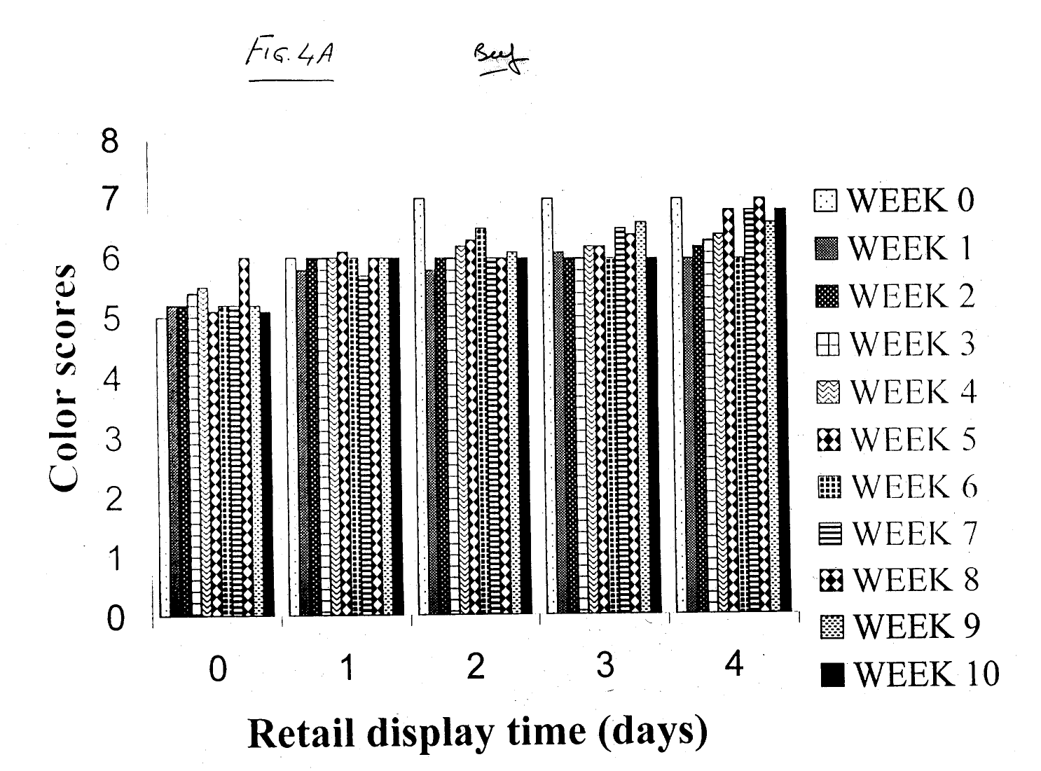

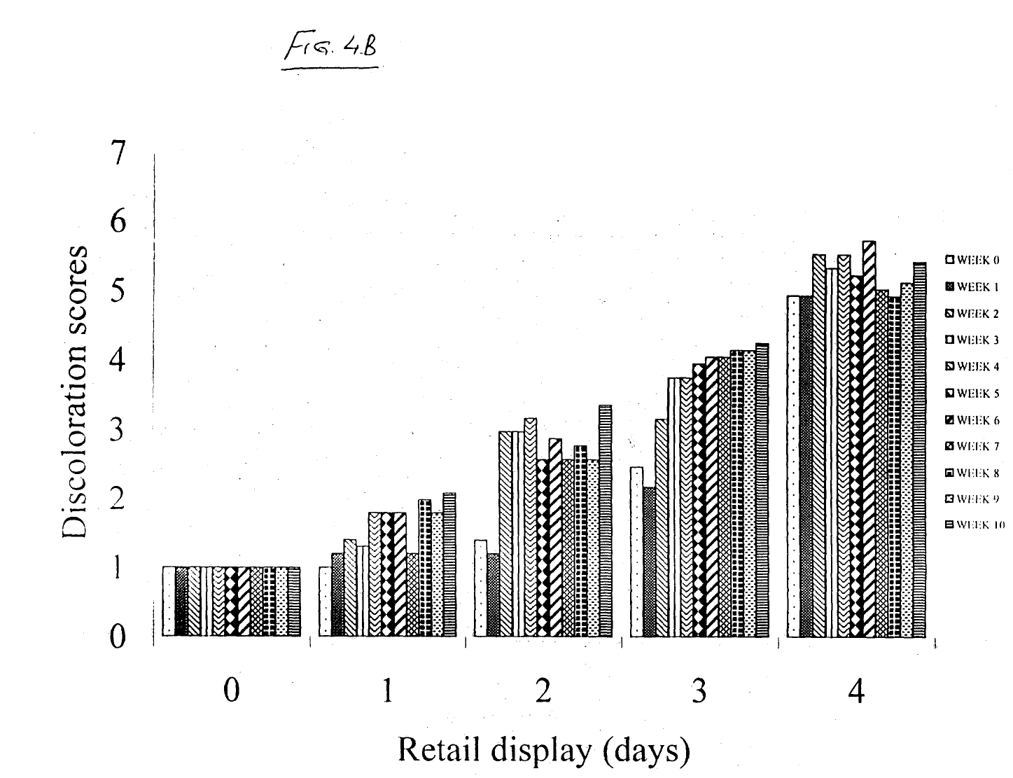

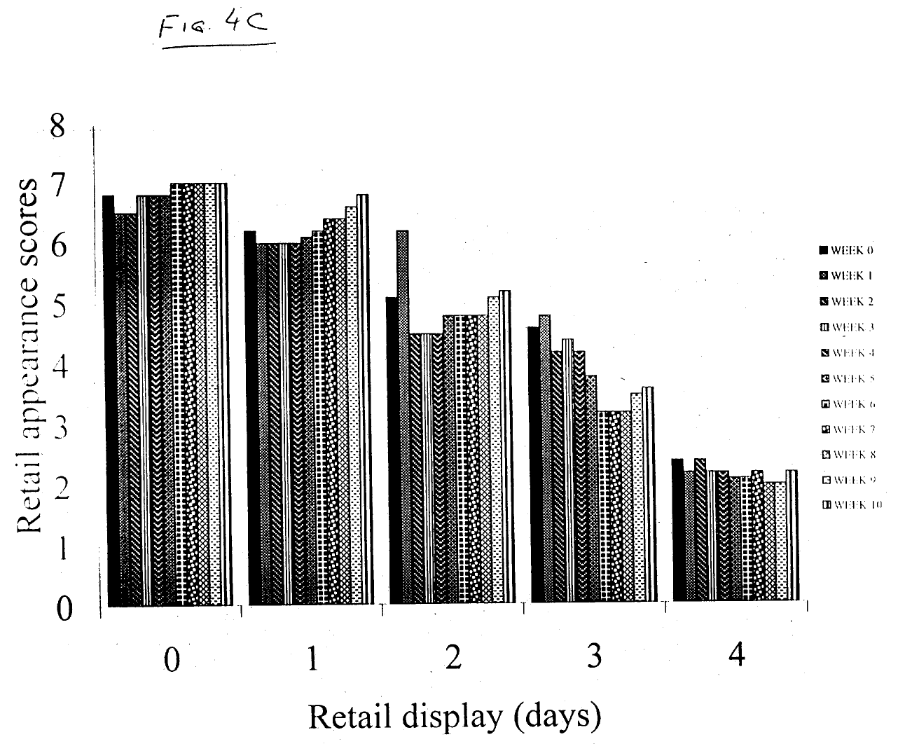

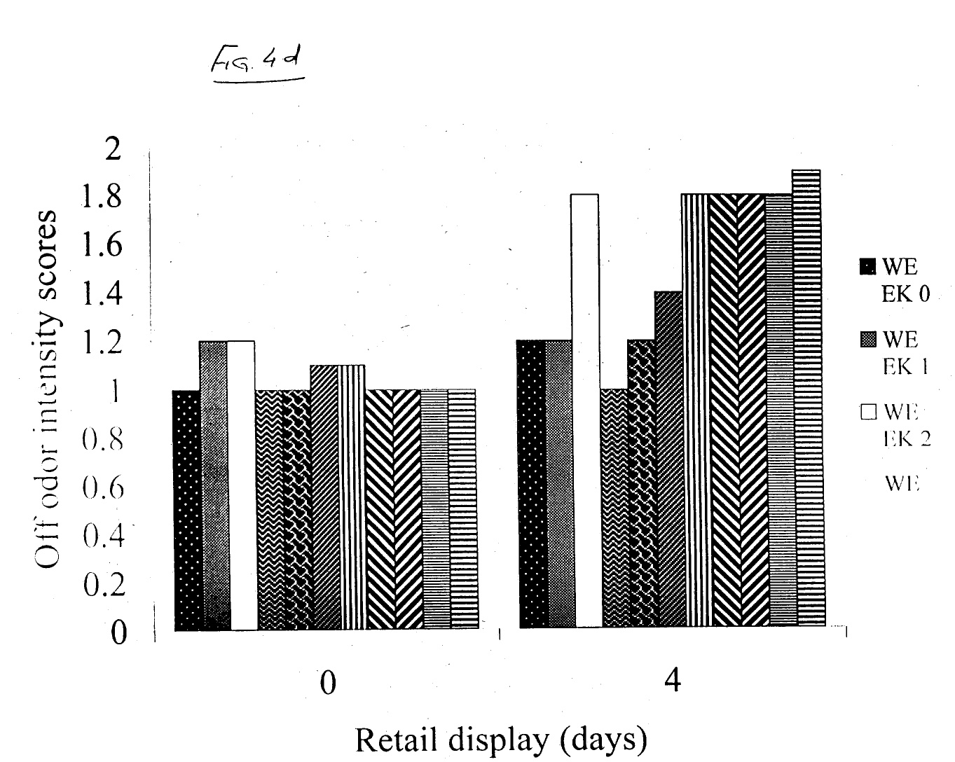

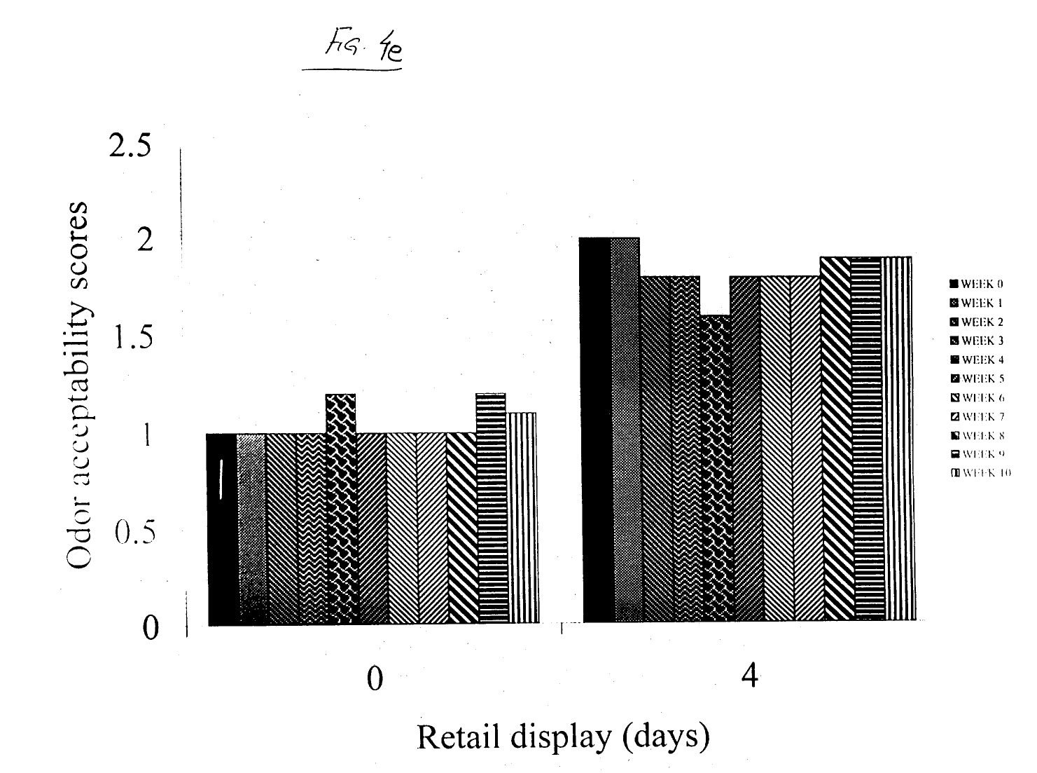

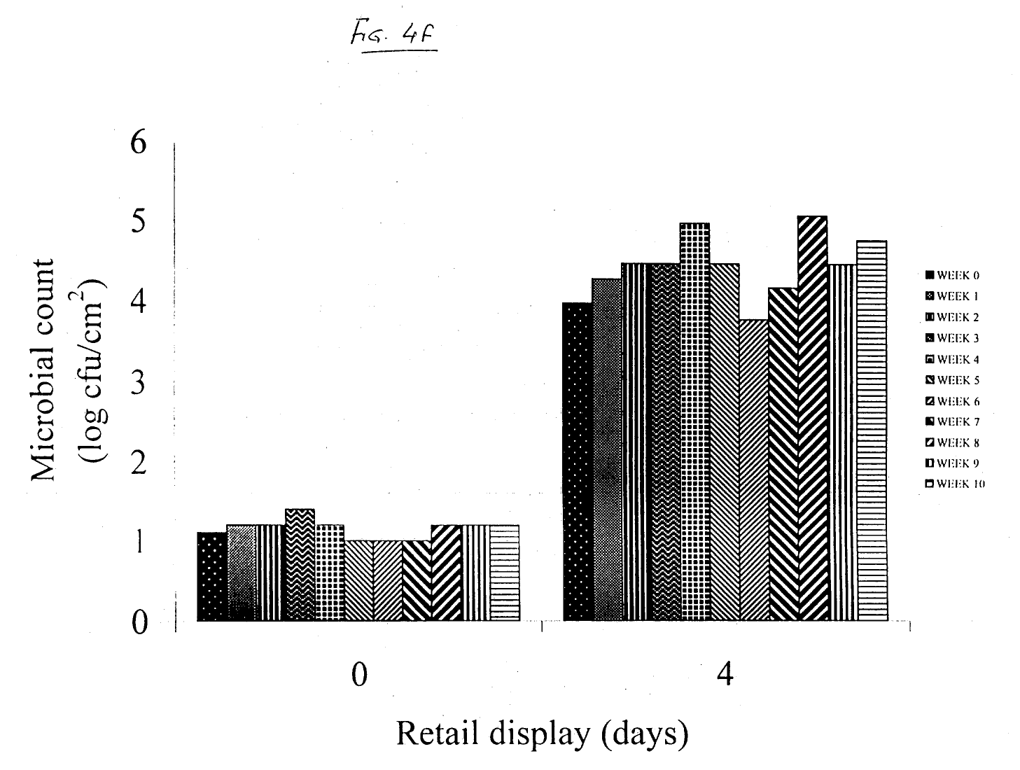

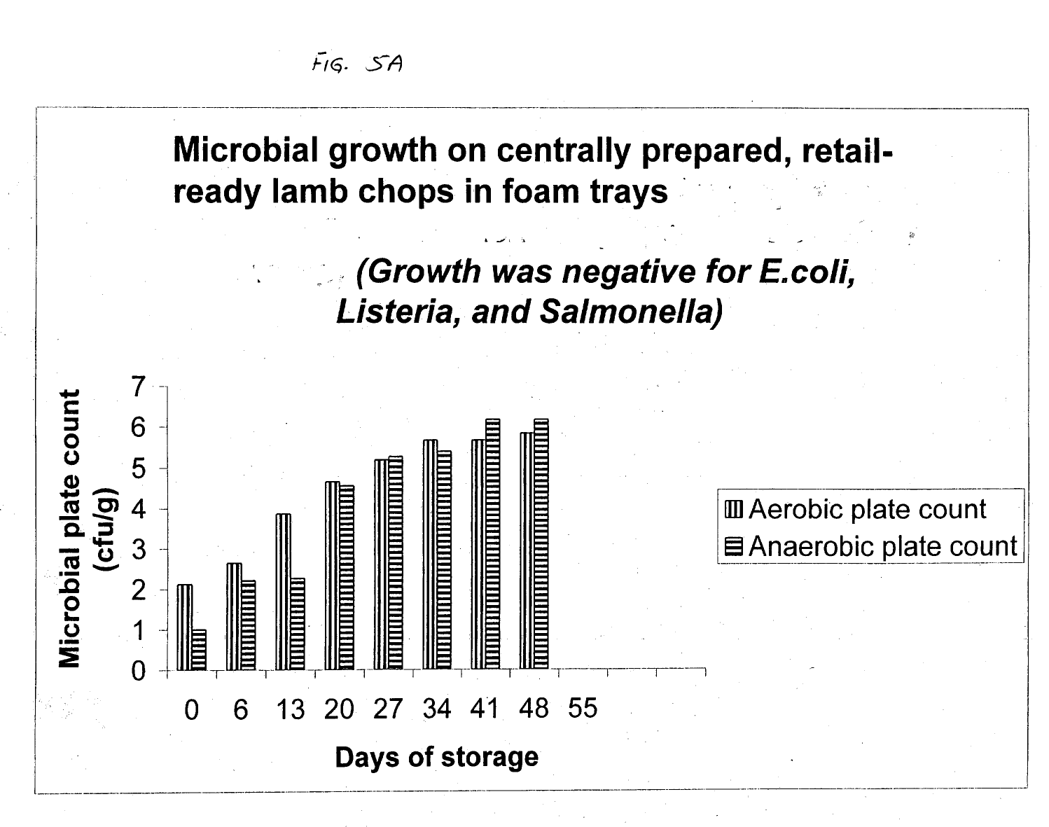

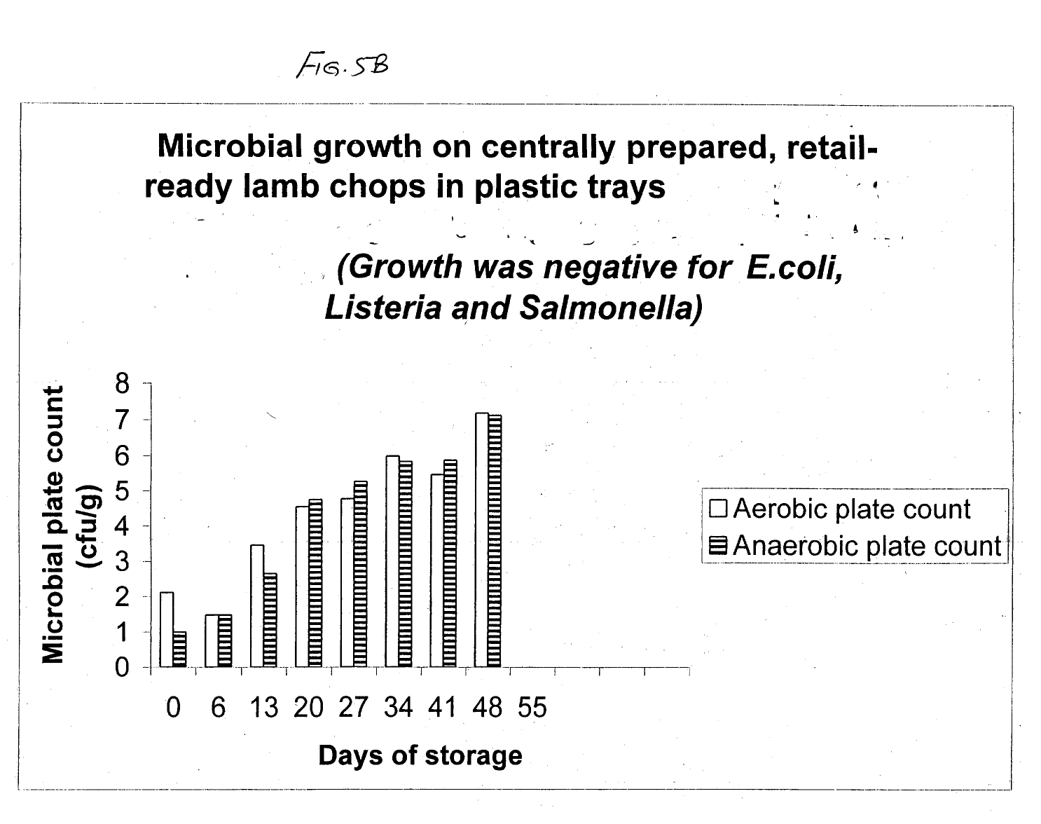

Discoloration: On day 0, all steaks received discoloration scores of 1 (0%: discoloration). After subsequent daily storage intervals, steaks packaged with no O₂ scavengers had discoloration scores of either 2 (1-10% discoloration), 3 (11-25% discoloration) or 4 (26-50% discoloration) (Table 2). Steaks packaged with type-one O₂ scavengers received a discoloration score of 1 (0% discoloration) after 2, 4, 7, and 8 d, and 2 (1-10% discoloration) after 1, 3, 5, and 6 d. Steaks packaged with type-two O₂ scavengers received discoloration scores of 1 (0% discoloration) at storage intervals of 1, 2, 4, 6 and 8 d, and discoloration scores of 2 (1-10% discoloration) at storage intervals of 3, 5, and 7 d (FIG. 3a).

Retail Appearance (RA): On day 0, control steaks received retail appearance scores of 7 (extremely desirable). After subsequent daily storage intervals, steaks packaged with no O₂ scavengers received RA scores of 5 (slightly desirable) or 6 (desirable) after 1, 2, 5, and 7 d. However, these scores were down to 3 (slight undesirable) or 4 (neither desirable nor undesirable) after 3, 4, 6, and 8 d of storage. Steaks packaged with type-one O₂ scavengers received RA scores of 6 (desirable) or 7 (extremely desirable) for all storage intervals, and steaks packaged with type-two O₂ scavengers received RA scores of 6 or 7 for all storage intervals, except after 7 d when they received RA scores of 5 (slightly desirable) (FIG. 3b).

Metmyoglobin on the Steak Surface

Metmyoglobin content was not significantly different for control steaks (with no O₂ scavengers) after most storage intervals when compared to fresh controls (p>0.05), except after 3 and 7 d. Metmyoglobin content increased from 3.5 on d 0 to 22.8% on d 3, then decreased to 4.7% on d 4, and again increased to 16. 1% on d 7 but decreased to 5.2% on d 8 (Table 3). Discoloration was visible at the edges of these steaks for all storage intervals. However, these areas were not exposed during reflectance spectrophotometry, and thus, the reflectance spectra did not report this discoloration, which would have undoubtedly increased the proportion ofinetmyoglobin (FIG. 3c).

Metmyoglobin content of steaks packaged with type-one O₂ scavengers was not significantly different when compared to control steaks (steaks packaged with no O₂ scavengers), for all storage intervals (p>0.05), except after 3 and 7 d of storage. Also, the metmyoglobin content was comparable with that of the fresh control for all storage intervals (p>0.05) (FIG. 3c).

The metmyoglobin content of steaks packaged with type-two O₂ scavengers was not different when compared with fresh controls and steaks packaged with type-two O₂ scavengers, for all storage intervals (p>0.05). However, steaks packaged with no O₂ scavengers had higher metmyoglobin content than the steaks packaged with type-two O₂ scavengers after 3, and 7 d of storage (p<0.05). differences were most noticeable at 2, 3, 6, and 7 d of storage, where the metmyoglobin content of steaks packaged with type-two O₂ scavengers was reduced to zero (FIG. 3c).

Discussion

Reduced O₂ concentration has been demonstrated to have an adverse effect on meat color, and PM has been shown to have the least color stability, discoloring rapidly even at very low O₂ concentrations (<100 ppm) irrespective of the storage temperature. Consequently, O₂ absorbent technology might be used in conjunction with CAP to prevent inevitable transient discoloration, and this constituted the hypothesis of the present study. On day 0, the O₂ concentration was 78 ppm and this rose to 477 ppm in master packs without O₂ scavengers after 1 d of storage. Master packs containing O₂ scavengers had no measurable O₂ at most storage times, except after 1 and 2 d in the case of type-one O₂ scavengers. As a consequence, steaks with O₂ scavengers had low metmyoglobin content and almost no discoloration, which resulted in significantly higher RA scores. Steaks packaged without O₂ scavengers had an increase in metmyoglobin content from d 0 to d 3 of storage. After 4 d storage metmyoglobin content decreased, but then gradually increased until after 7 d storage, when it decreased again. This indicated these steaks underwent two cycles of transient discoloration, regaining color due to MRA or other reducing factors. Steaks packaged with O₂ scavengers did not undergo such transient discoloration. Moreover, steaks packaged with type-two O₂ scavengers had lower metmyoglobin content than the fresh control after all storage intervals, and metmyoglobin content was reduced to zero in some cases. In the present study, PM steaks expected to have poor color stability were used, but, very low metmyoglobin contents and high RA scores were observed in samples packaged with O₂ scavengers. Thus, the hypothesis of combining O₂ absorbent technology with CAP to prevent transient discoloration was proven.

The O₂ concentration during initial packaging was 78 ppm, and it went up to 477 ppm after 1 d of storage. therefore the amount of time required to reduce the O₂ concentration from 477 to 0 ppm would be almost four times the half-life of O₂ in the package atmosphere. For type-one and type-two O₂ scavengers, incorporating the number of scavengers used in the study, the O₂ half-life is 0.31 and 0.65 h, respectively (Example 1). Steaks will also contribute to the total O₂ absorbing capacity to some extent (<10%). Thus, at 1±0.5° C., transient discoloration of PM steaks can be presented if residual O₂ is reduced to 0 ppm within 3 h of pack closure.

Selection of a suitable retail-packaging system is another critical aspect of master packaging technology using CAP. It is evident from the results of the present study that the O₂ concentration in the master pack may initially increase drastically after packaging. Such an increase may be attributed to O₂ entrapment either in the absorbent pad or under the over-wrap film during evacuation. In addition, meat tissue itself initially releases dissolved, unreacted O₂ causing reduction of oxymyoglobin to deoxymyoglobin in the presence of low partial pressures of O₂ in the head space during CAP storage. This increase is inevitable. Therefore, O₂ entrapment must be minimized to prevent O₂ concentrations increasing in the pack to the point where transient discoloration may occur.

It has been found that over-wrap film with high O₂ permeability acts as an O₂ barrier at low initial O₂ concentrations (Example 1), and the barrier property increases at low storage temperatures. It is also evident that O₂ concentration may increase due to entrapment of O₂ in either the soaker pad or the over-wrap. It is recommended that each retail tray within the master pack contain O₂ scavengers to absorb any O₂ entrapped inside tray, which may affect meat color. This conclusion was reached during concurrent work by the inventor (Gaurav Tewari) discussed above, which indicated less discoloration occurred on steak surfaces in a system where O₂ scavengers were placed in the master pack. Placing O₂ scavengers directly inside the retail tray will also reduce the number of O₂ scavengers required.

The present work was designed to examine meat samples with the highest pigment instability stored under conditions conducive to discoloration during centralized distribution. Beef (PM) was placed in over-wrapped retail trays (which may have O₂ entrapped in the absorbent pad or over-wrap or both). Although a storage temperature of 1±0.5° C. is not recommended to optimize storage life of fresh meat cuts in centralized systems, it is closer to the optimum (−1.5° C.) than the commercial norm. Rates of myoglobin oxidation and metmyoglobin reducing activity increase and decrease, respectively, at temperatures above 0° C. Thus, better results can be expected at −1.5° C. Nevertheless, under worst-case conditions, the use of O₂ scavengers in conjunction with CAP prevented transient discoloration of PM beefsteaks. It is probable that the system used in the present study will easily prevent transient discoloration in beef steaks with higher color stability, such as LD, especially if stored below 0° C. Oxygen scavengers have the potential of preventing transient discoloration of all centrally prepared beef cuts, but, factors such as selection of packaging systems, O₂ scavenger type, and package atmospheres (N₂/C O₂) may affect results.

### EXAMPLE 4

### Total Shelf Life of Retail-Ready Meat Cuts using the Designed system Incorporating 100% Nitrogen Atmosphere and Optimized Oxygen Absorption Technology

Exploration of an appropriate master-packaging system, which will minimize both color instability and microbial spoilage, is imperative for centralized meat operations. Although research has been done on microbiological and sensory aspects of meat during centralized meat packaging under various modified atmospheres, meat discoloration due to residual O₂ in controlled atmospheres remained a challenge as the rate of metmyoglobin formation increases at low partial pressures of O₂. Beef steaks made from muscles of poor color stability such as psoas major (PM), discolor rapidly even at O₂ concentrations of <100 ppm and sub-zero temperatures, resulting in short storage life in CAP followed by short display life. Consequently, application of oxygen absorben technology in conjunction with CAP became an attractive option. In addition, a suitable retail packaging system is required to reduce residual O₂ in the controlled atmospheres due to the possibility of O₂ entrapment within retail trays. the objective of the present study was to examine the storage and retail display life of master packaged beef steaks (PM) stored under 100% nitrogen atmosphere along with O₂ absorbents at −1.5° C.

Materials and Methods

Oxygen Scavengers

O₂ scavengers, based on iron chemical system, were used in the study. These O₂ scavengers are based on iron-chemical systems, and were activated by applying moisture.

Master Packaging, Storage, and Sampling of Steaks

Fresh beef tenderloins (psoas major, PM) from animals slaughtered 24 h previously, were obtained from a local beef abattoir. Eighty steaks of 2 cm thickness, were prepared from these tenderloins. Each steak was placed on a 152×114 mm absorbent pad in a 216×133×25 mm (L×W×H) solid polystyrene tray with 8 O₂ scavengers placed underneath the absorbent pad. Each retail tray was over-wrapped with a shrinkable O₂ permeable film with an O₂ transmission rate of 8000 mL/(m²24 h) at 23° C., 70% R.H., and atmospheric pressure. After sealing, the film was shrunk to the tray using a hot-air gun. Then, two 3-mm holes were made at the opposite corners of the tray to allow for exchange of atmospheres during gas flushing. Four such retail trays were placed in an EVA co-extruded master pack with O₂ transmission-rate of 0.55 mL/(m²24 h) at 23° C., 70% R.H., and atmospheric pressure. The bags were evacuated, filled with 4.5 L of N₂, and sealed using a CAP machine. Twenty such bags were prepared. Additionally, 8 retail trays were prepared and treated as un-stored controls.

The master packs were stored at −1.5±0.5° C. On week 0 and d 0 of retail display, four steaks in retail trays, serving as fresh, un-stored controls, were analyzed for visual, odor, taste, and microbial characteristics. Also, reflectance spectra were obtained from the surface of these steaks. The visual analysis was done daily for 4 d, and similarly reflectance spectra were obtained daily. On d 4 of retail display, odor, taste, and microbial analyses were done in addition to visual examination and reflectance spectra measurements. Two master packs were opened at subsequent 1 wk storage intervals for 10 wk. The O₂ concentration in each bag was measured immediately before opening the bag.

Display and Sampling of Retail Trays

Upon removal from primary CAP storage at weekly intervals, and on day 0 of retail display, master packaging was removed and each group of 8 retail trays was placed in the center of the display shelf:

The displayed PM steaks were examined for color, discoloration, retail-acceptability, off odor intensity, odor acceptability, and odor description, 45 min after opening of the master-packages. Also, reflectance spectra from the steak surfaces were obtained to estimate metmyoglobin, deoxymyoglobin, and oxymyoglobin. After visual scores and reflectance spectra were obtained, two steaks (one from each master bag) were removed from the display case, and samples were taken for microbial analysis. Then the steaks were cooked and analyzed for flavor acceptability and off-flavor intensity. The remaining six steaks were left in the display case, and were examined for visual characteristics at subsequent intervals of 24 h and reflectance spectra at 12 h for 96 h. After 96 h of retail display, the steaks were analyzed in a similar fashion as on day 0 of retail display. During sensory evaluation, the samples remained in the display case and the well-trained panelists made judgments independently. A similar procedure was repeated for all storage intervals.

Visual Assessment of Master-Packaged Steaks

A five-member panel was used for the subjective evaluation of the steaks. Color scores were assessed using an eight-point descriptive scale: 0=Completely discolored, 1=White, 2=Pale pink, 3=Pink, 4=Pale red, 5=Bright cherry red, 6=Slightly dark red, 7=Moderately dark red, 8=Extremely dark red. Surface discoloration was evaluated using a seven-point descriptive scale: 1=0% (none), 2=1-10%, 3=11-25%, 4=26-50%, 5=51-75%, 6=76-99%, 7=100%. Retail appearance was assessed on a seven-point hedonic scale: 1=Extremely undesirable, 2=Undesirable, 3=Slightly undesirable, 4=Neither desirable nor undesirable, 5=Slightly desirable, 6=Desirable, 7=Extremely desirable.

Odor Assessments of Master-Packaged Steaks

A five-member panel was used for the odor assessment. Off odor intensity scores were assessed using a four-point descriptive scale: 1=No off odor, 2=Slight off odor, 3=Moderate offodor, 4=Prevalent off odor; odor acceptability scores were assessed using a five-point scale: 1=Acceptable, 2=Slightly acceptable, 3=Neither acceptable nor unacceptable, 4=Slightly unacceptable, 5=Unacceptable; and off odor description scores were assessed using a six-point scale: 1=Sour-sulfur rotten eggs), 2=Sour-lactic acid, 3=Putrid, 4=Dirty socks, 5=Floral/Fruity, 6=Other.

Microbial Analysis

A 10-cm2 sample was obtained at each sampling time (on d 0 and 4 of each storage interval) from each of the two steaks using a sterile cork borer. Then, the sample was placed into a stomacher bag with 10 mL of 0.1% peptone solution and was massaged for 120 s using a commercial stomacher, yielding a dilution of 10°. The homogenate was further diluted 10-, 100-, 10000-, and 1 00000-fold, after which 0.1 mL volumes of undiluted homogenate and of each dilution prepared, were spread on duplicate plates of APT (all Purpose Tween). The plates were incubated aerobically for 3 d a 25° C. The micro flora was determined from plates bearing 20-200 colonies.

Statistical Analysis

The main effects of storage interval and retail display period were examined statistically using analysis of variance (proc ANOVA, SAS Institute Inc., Cary, N.C.) at an a level of 0.05.

Results

Measurement of O₂ Concentration

The O₂ concentration was <100 ppm at initial packaging, and after any CAP storage interval it was reduced to 0 ppm, except after 8 wk storage when 24 ppm of O₂ was measured in one bag.

Evaluation of Steaks

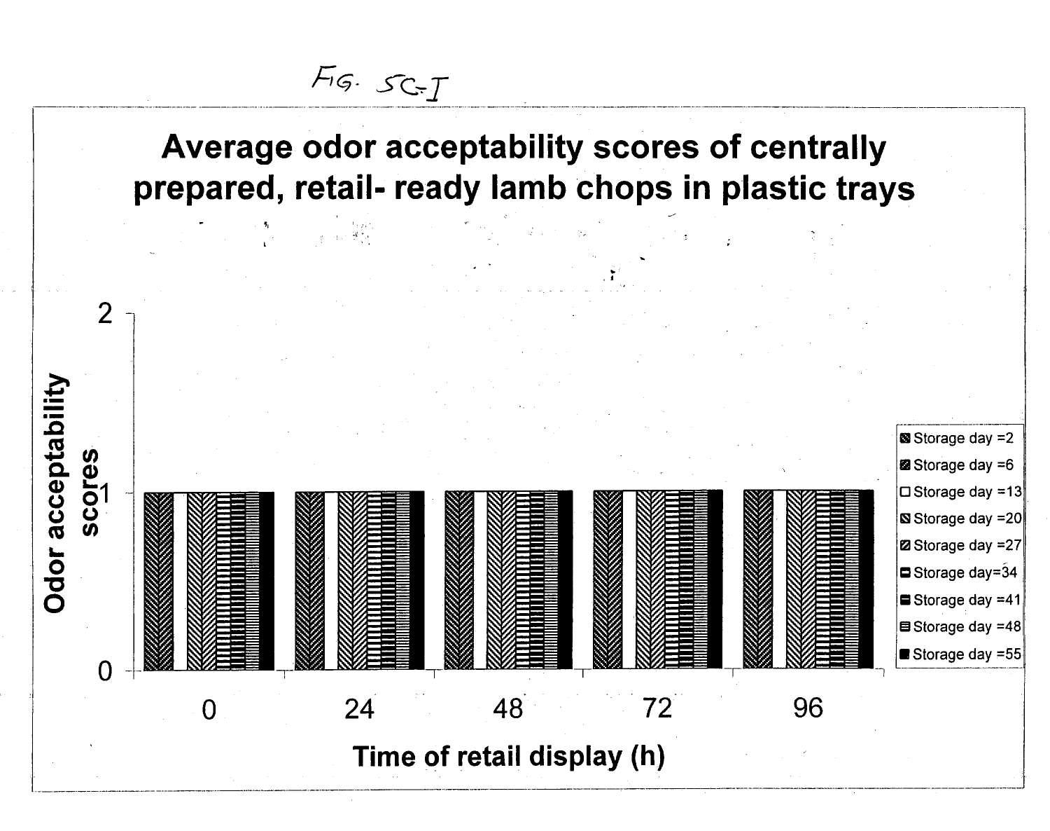

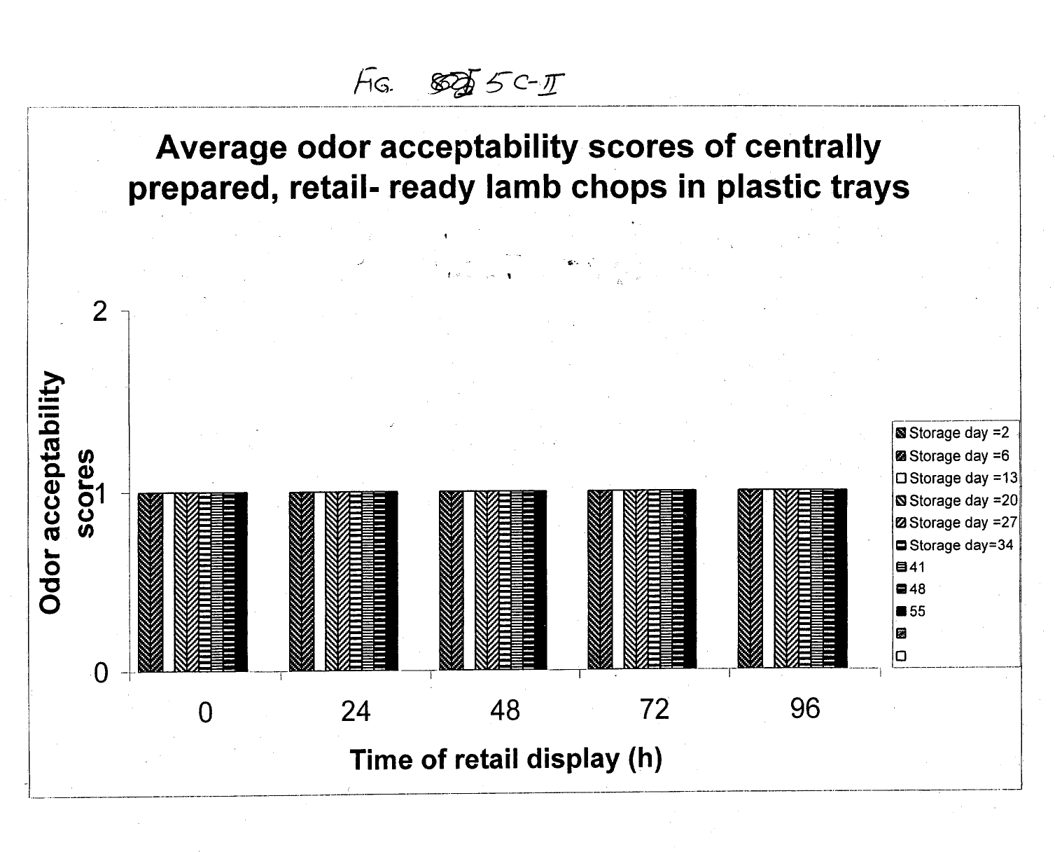

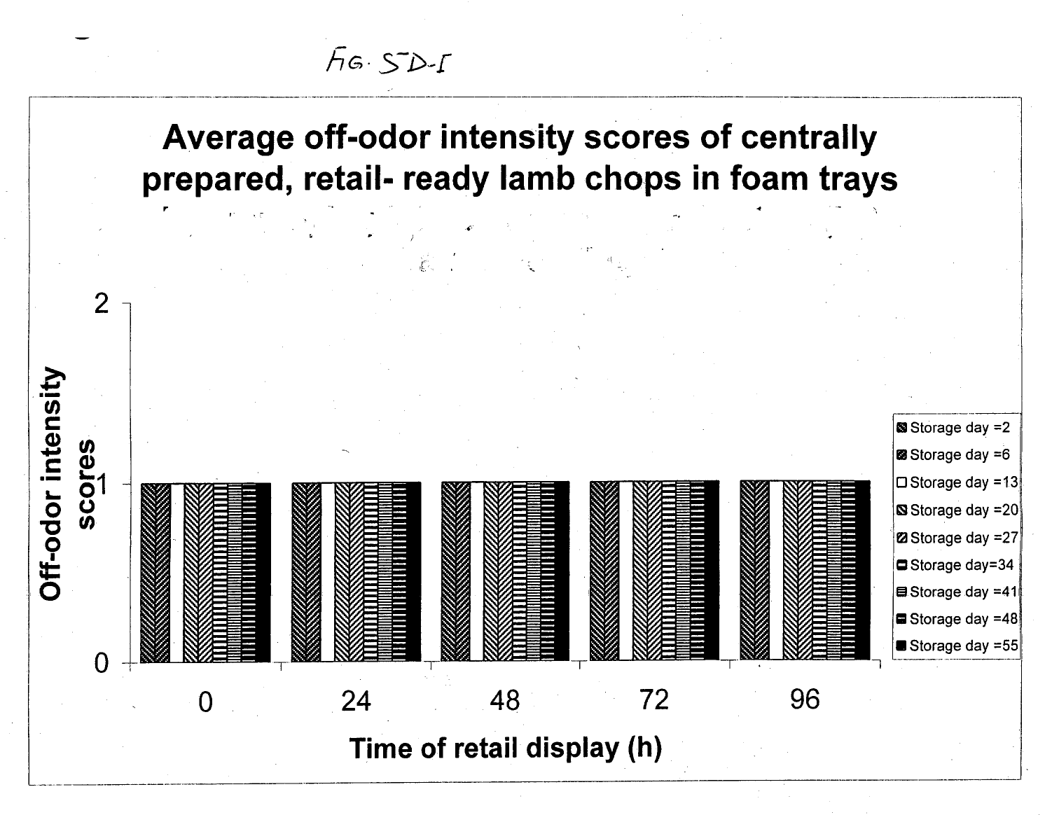

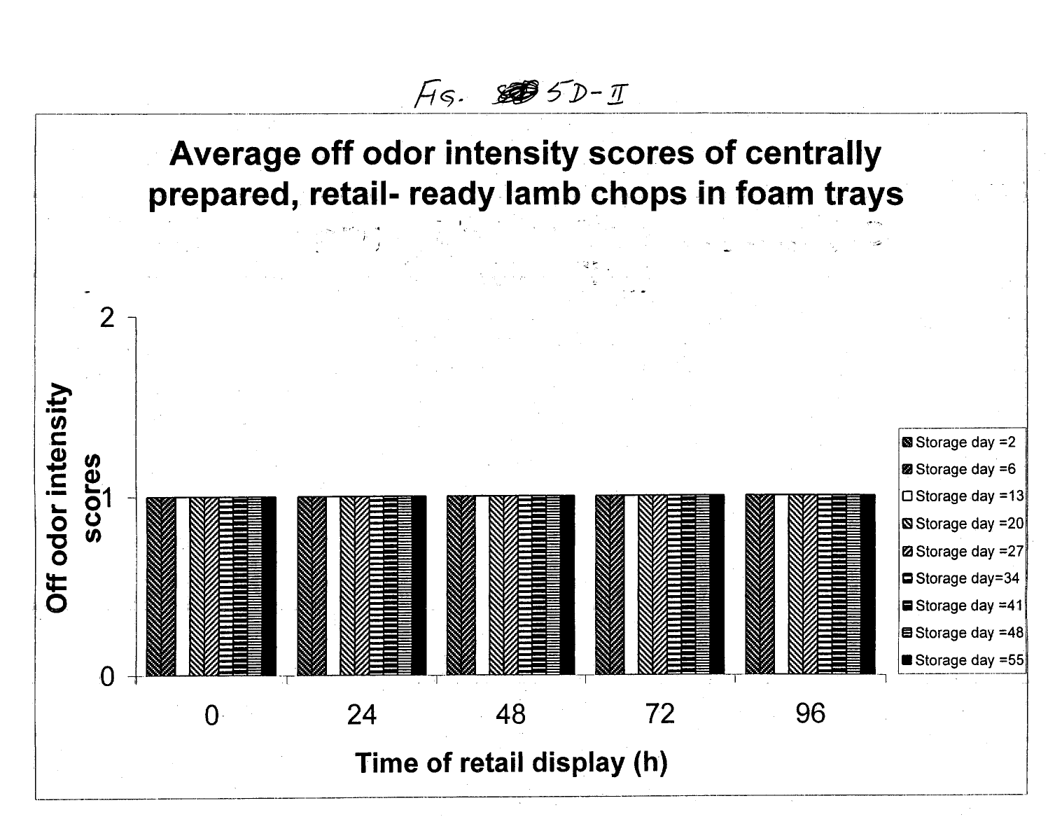

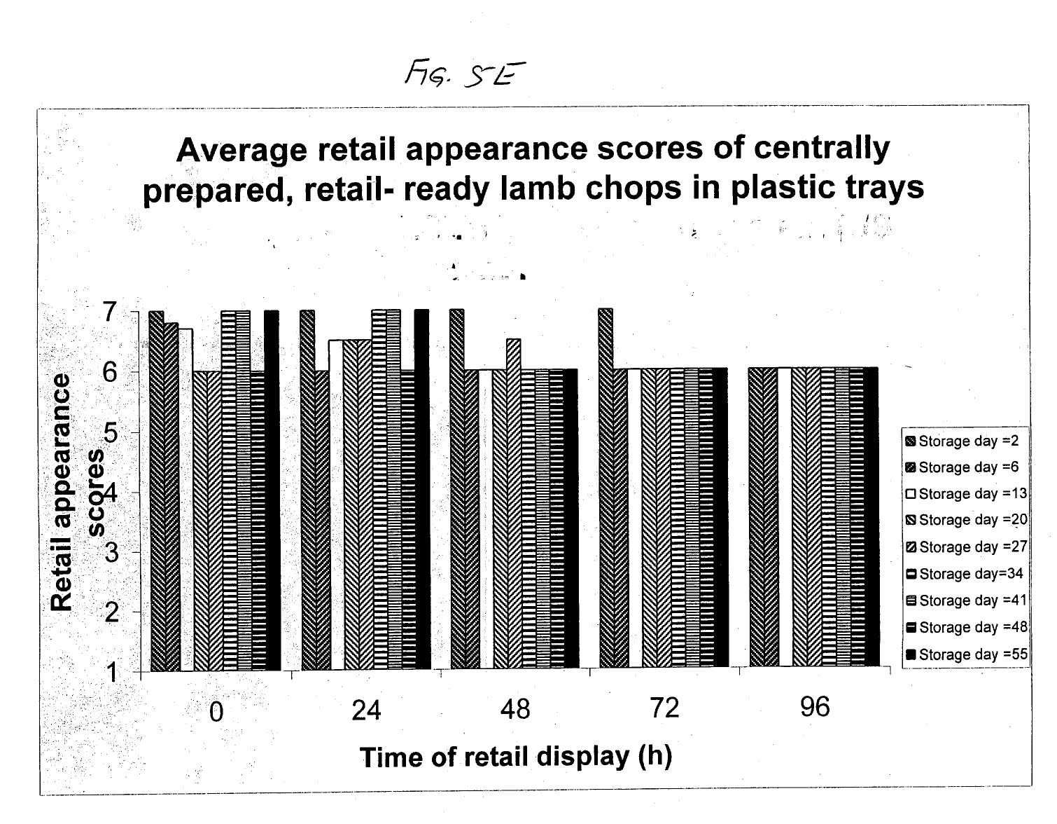

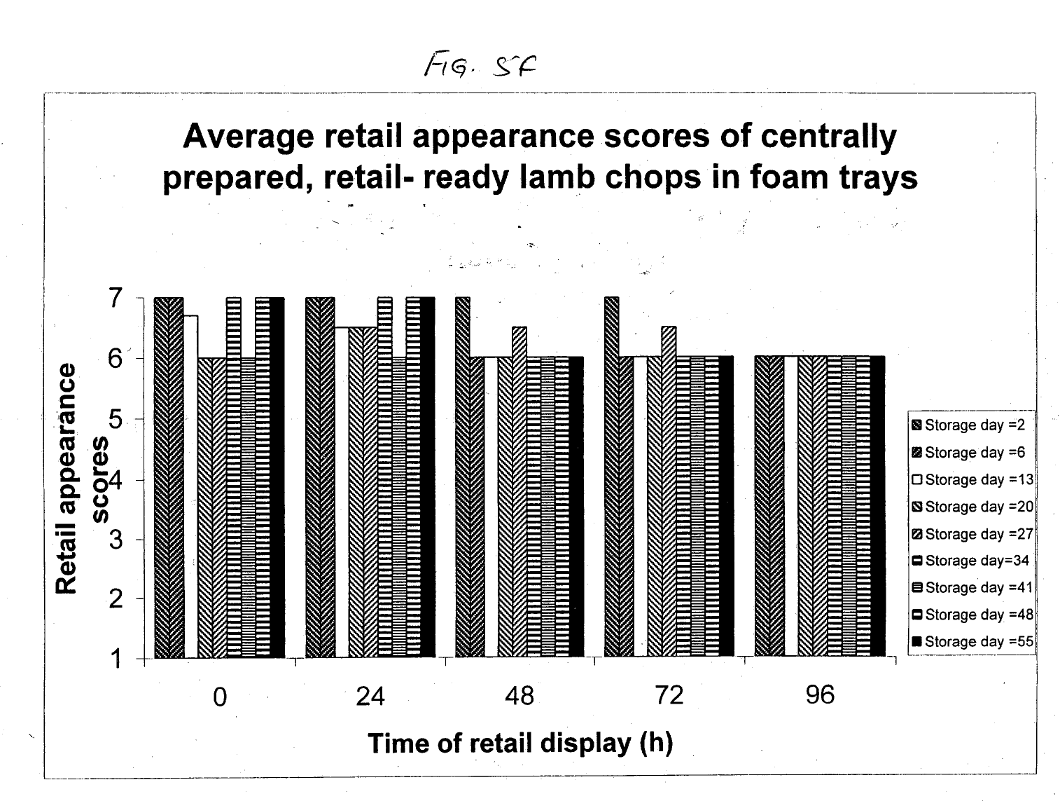

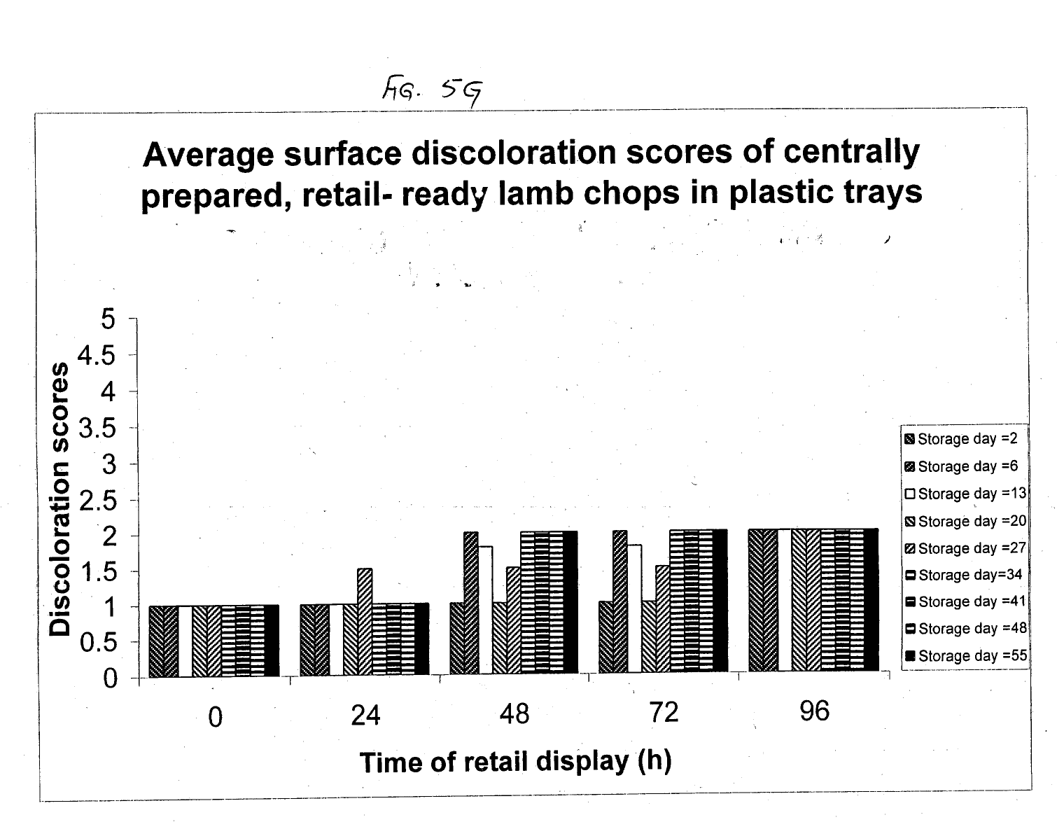

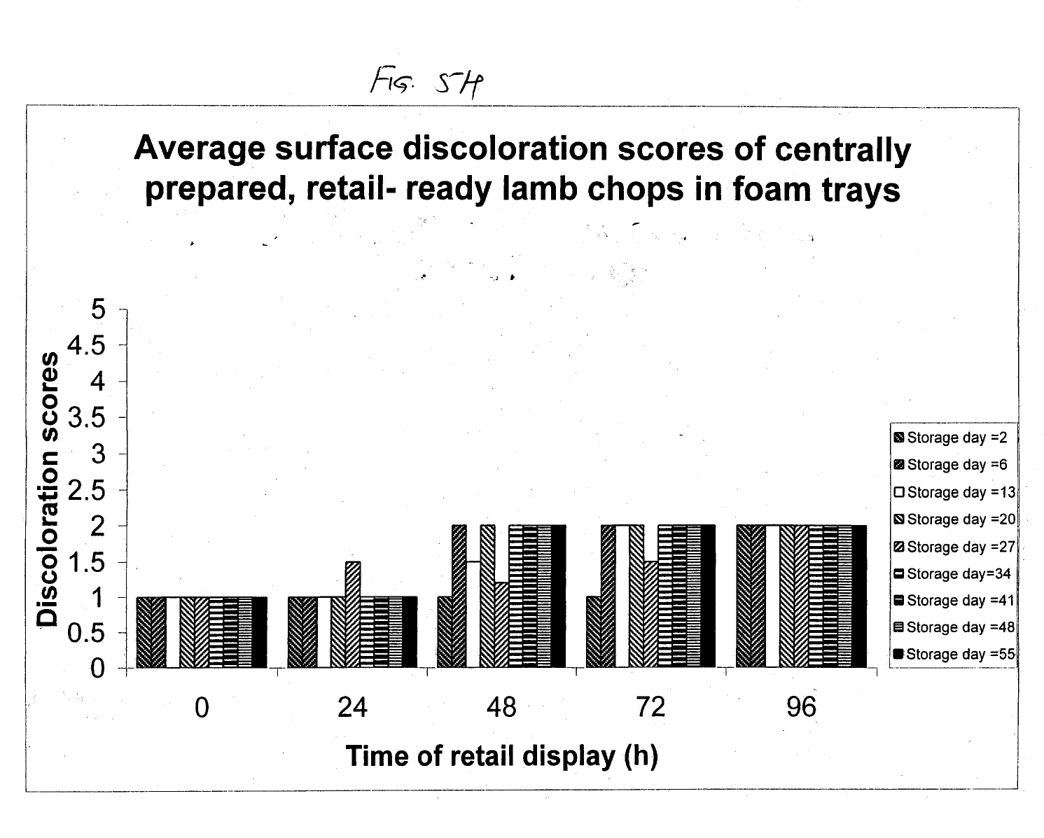

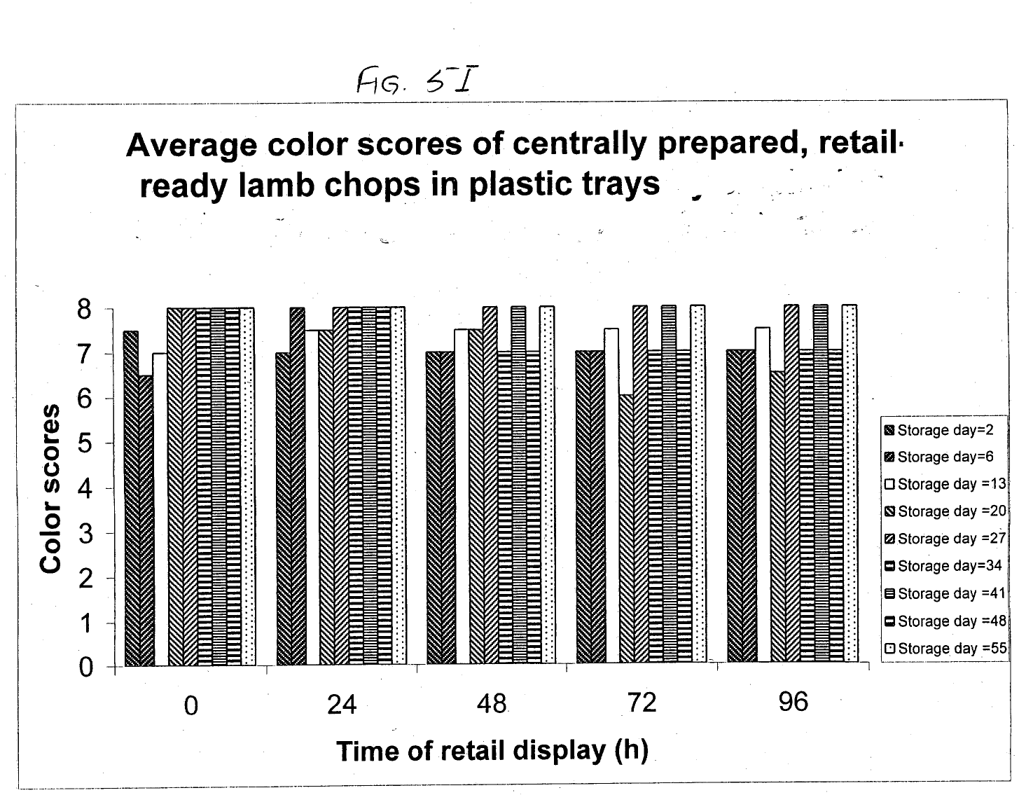

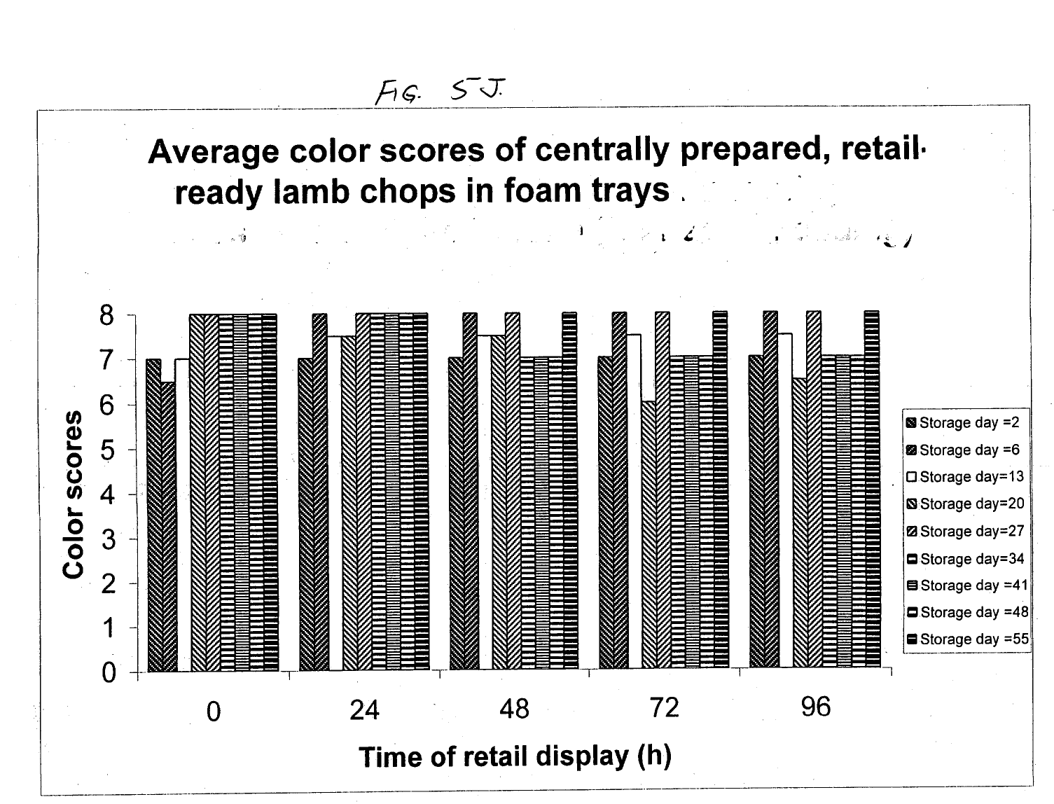

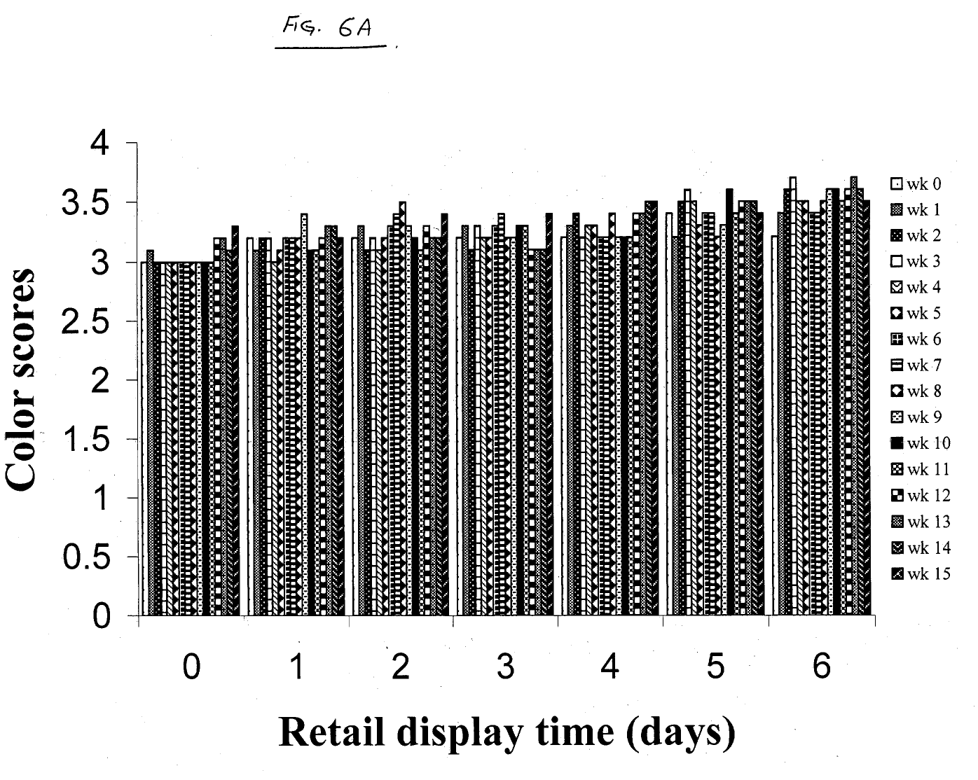

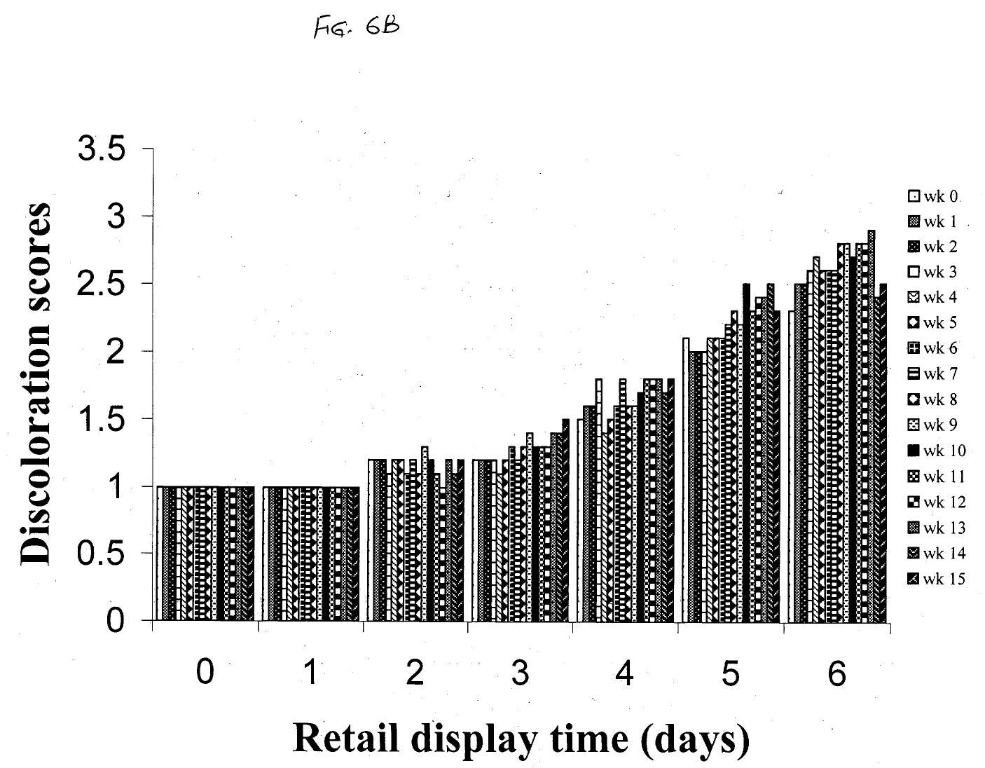

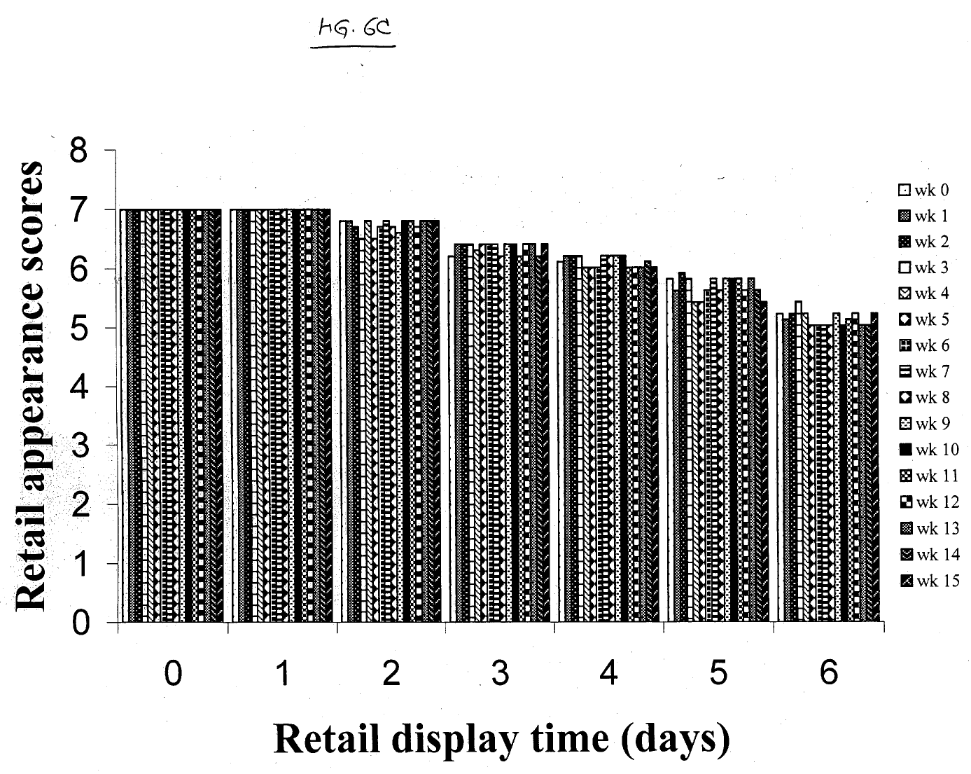

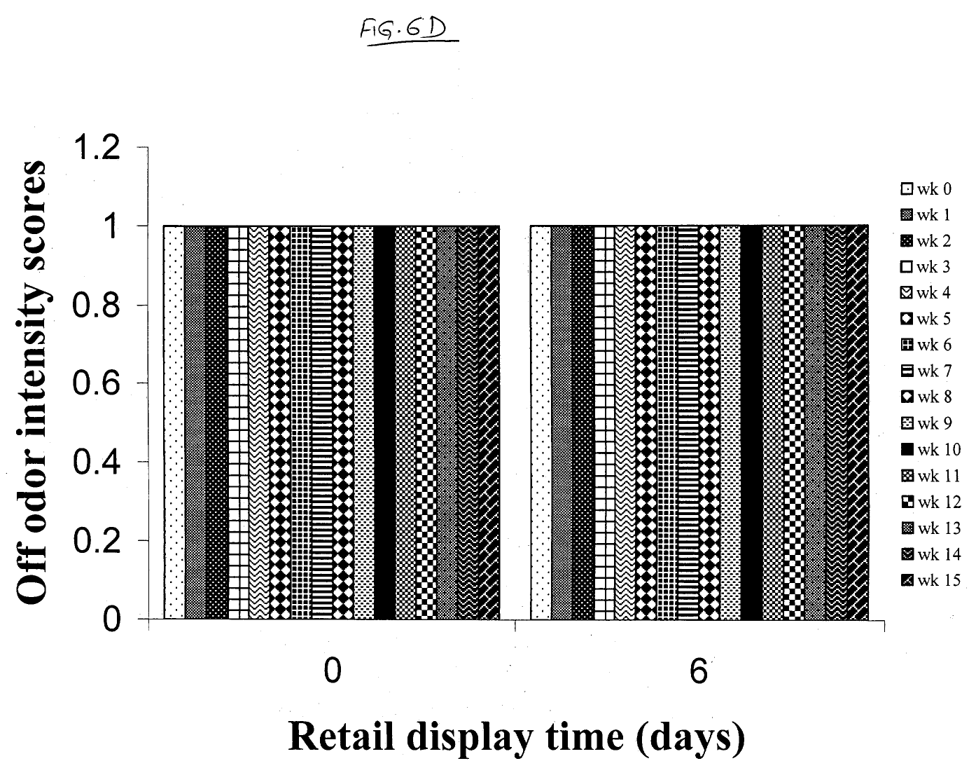

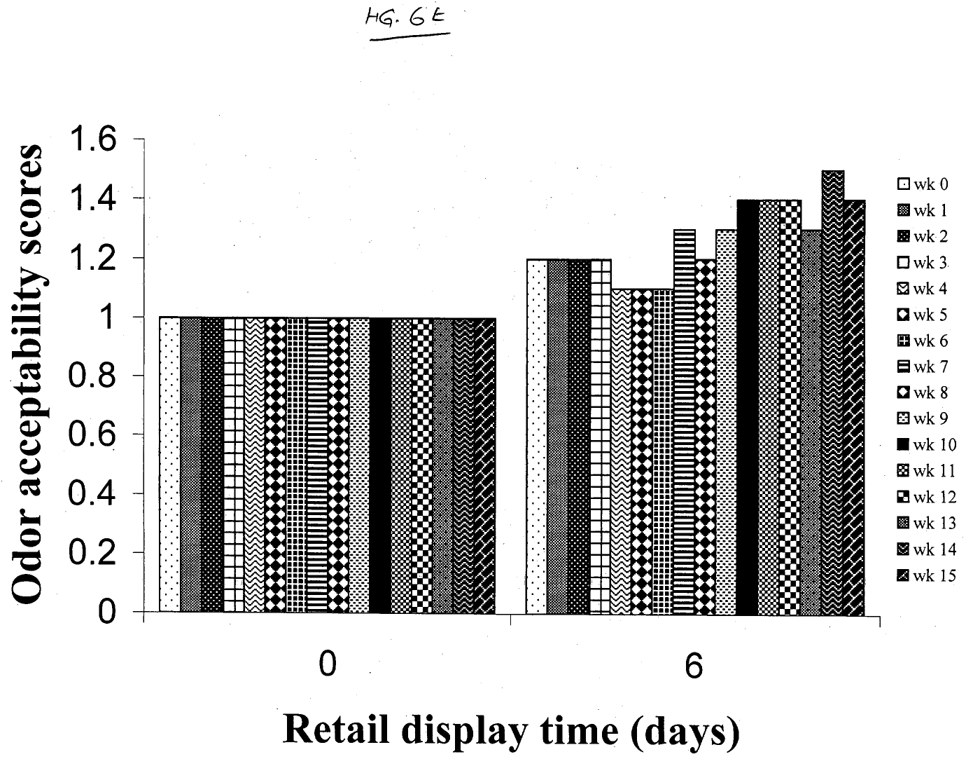

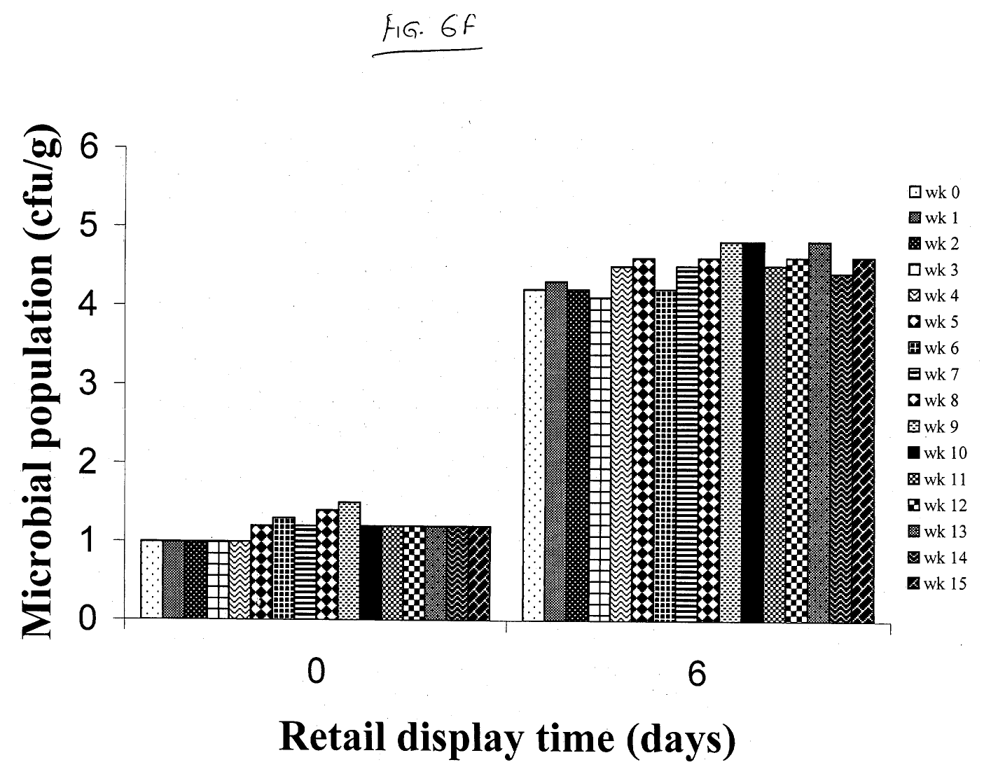

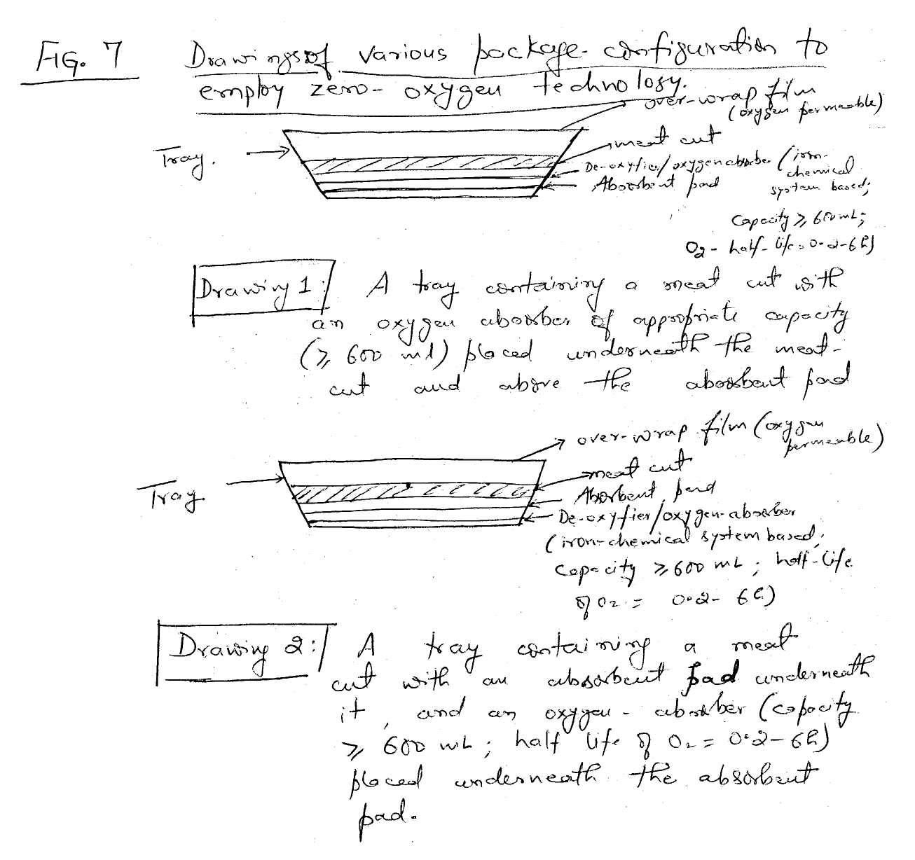

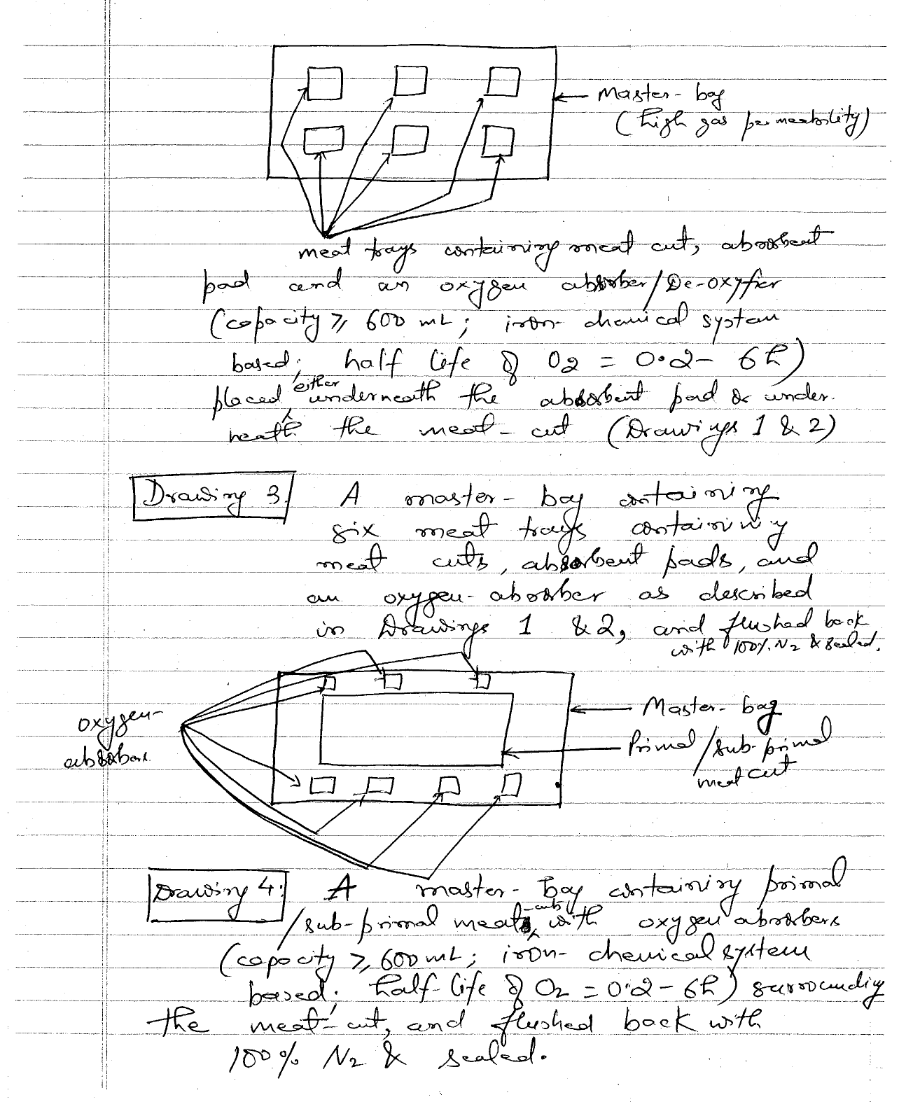

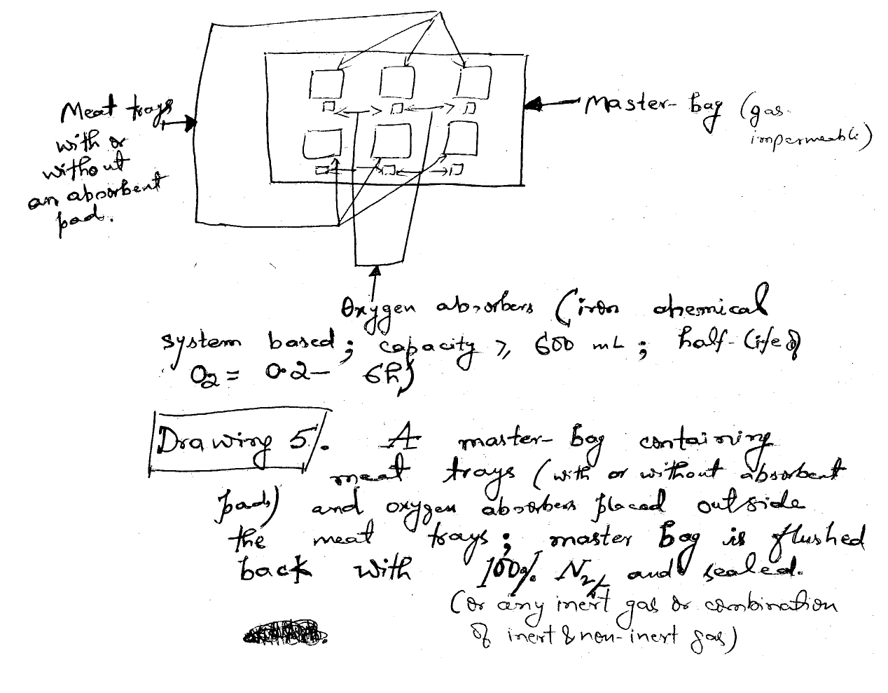

Although significant (p<0.05) differences existed between CAP storage intervals in visual color rating on d 0 of retail display, that is, when steaks were removed from storage, all steaks were perceived to be bright cherry red or slightly dark red and no differences of practical importance existed. Generally, steaks remained stable in color until they became extremely dark (FIG. 4a) or completely discolored (data not shown) on the fourth day of retail display for any storage interval. Due to leak in the master pack, steaks were completely discolored on d 1 of retail display after 1 wk of storage. These steaks were removed from retail display and not analyzed further.

On d 0 of retail display for any CAP storage interval, no significant (p>0.05) surface discoloration was reported on the steaks. The retail display period significantly (p<0.05) increased the amount of surface discoloration on the steaks for any CAP storage interval. However, the steaks discolored at a faster rate than the un-stored controls for all storage intervals, and were relatively extensively discolored (p<0.05) (FIG. 4b). Steaks were extremely desirable in retail appearance on d 0 of retail display for any storage interval (p>0.05). Despite the fact that they deteriorated more rapidly in retail appearance than the un-stored controls, they were still in the acceptable range (about 3.5) on the third day of retail display (FIG. 4c).

From a practical perspective, steaks were perceived to have no off-odors on d 0 of retail display for any storage interval, however, significant differences existed between storage intervals with respect to off odor intensity ratings (p<0.05). The maximum difference in ratings was 0.3 of a panel unit, which is of marginal practical importance. Even on d 4 of retail display, only slight off odors were reported (FIG. 4d). Generally, odor of steaks was acceptable on day 0 of retail display (FIG. 4e). Maximum differences of 0.3 of a panel unit were noticed after 7 and 8 wk of CAP storage, which has little practical significance. Despite significant (p<0.05) differences between storage intervals on odor acceptability ratings of d 4 of retail display, all steaks were perceived to be slightly acceptable (FIG. 4e).

Despite differences (p<0.05) between CAP storage intervals on microbial numbers at d 0 of retail display, steaks had <10² cfu/cm² of total organisms, and no differences of practical importance existed. In most cases, microbial numbers were comparable with those of un-stored controls (FIG. 4f). On d 4 of retail display, microbial numbers were <100 cfu/cm² in all cases (FIG. 4f).

Discussion

Centrally prepared retail beef cuts stored in controlled atmospheres containing nearly 100% carbon dioxide (CO₂) or nitrogen (N₂) which may have small amounts of O₂ are susceptible to the formation of metmyoglobin, due to the presence of residual O₂. If the O₂ concentration is not excessive, the meat tissue will metabolize some of the residual O₂ and any metmyoglobin formed will be reduced to deoxymyoglobin as a result of metmyoglobin reducing activity (MRA) within the muscle tissue. It is reported that in packaged fresh beef 2-4 d are required for reduction of metmyoglobin to deoxymyoglobin. When stored meat is removed from the controlled atmosphere, it blooms to the desirable, bright red color associated with freshly cut meat, but this will not occur if a substantial amount of metmyoglobin is present. the MRA of muscle tissue is limited in stability and once exhausted is not available to convert metmyoglobin back to myoglobin. To overcome this disadvantage and address the issue of transient discoloration during CAP storage of fresh beef, the present work was undertaken to combine the efficacies of CAP storage of fresh beef, the present work was undertaken to combine the efficacies of CAP storage and O₂ absorbent technology and demonstrate the shelf life extension of retail-ready fresh beef under these conditions. Tenderloins are known to have very poor color stability and discolor rapidly even at very low O₂ concentrations and at a storage temperature of −1.5+0.5° C. The effect of intermuscular differences on color stability adds another variable that complicates continuous prevention of meat discoloration. Biochemical factors, such as oxygen consumption rate (OCR) and MRA, have been reported to be different for different muscles. Therefore, the system was tested using a beef muscle type that had poor color stability and represented a worst-case challenge for centralized meat operations. The performance of O₂ absorbent technology was also put on test during this study for its ability to prevent transient discoloration by rapidly reducing the residual O₂ concentration to essentially 0 ppm, and thereby preserving the limited MRA of muscle. retained MRA may further enhance retail display life of steaks. In a prior study by the inventor (Gaurav Tewari), it was shown that steaks packaged with an optimum O₂ absorbing capacity had more retail display life when compared with steaks packaged without such capacity. Thus, the system used in the present study was believed to have the capability to provide solutions for the major problems of residual O₂ concentrations encountered in centralized fresh meat distribution.

For all CAP storage intervals, the steaks had acceptable visual, odor, and flavor scores on day 0 of retail display. Additionally, metmyoglobin content and microbial growth were minimal, and in some cases even lower than in fresh controls on the day packs were opened and displayed. Along with a low storage temperature of −1.5±0.5° C., an important factor influencing microbial content was low initial microbial load. Beef tenderloins were used in the study, and these muscles are internally located and do not undergo much handling by meat-cutters as compared to other cuts. This protects them to some extent from cross-contamination, and hence yields low initial microbial load. The meat cuts used in the present study had very low initial microbial numbers, which would have delayed onset of spoilage levels of microorganisms, and thus may have reduced the occurrence of off-odors. It was not surprising that microbial growth and odor did not limit CAP storage and retail display life of steaks.

Due to the increased solubility of O₂ and reduction in the partial pressure of O₂ required for maximal metmyoglobin formation at sub-zero temperatures, maximum discoloration occurred several millimeters below the meat surface. Since meat is translucent, such discoloration is normally visible. The deeper in the tissue metmyoglobin occurs, the lower is its visibility, and this resulted in low levels of discernable discoloration and higher retail appearance scores during retail display. Also, use of optimum O₂ absorbing capacity in each retail tray prevented transient discoloration of beefsteaks, which probably retained MRA and delayed discoloration further. Prevention of such transient discoloration has been reported above. The combination of these hurdles resulted in reduced discoloration even on d 3 of the retail display period. Since the bright-red color of meat was restored, the steaks received acceptable retail appearance scores on d 3 of retail display for any CAP storage interval, after which the meat was in an unacceptable range. Thus, visual characteristics seem to be the limiting factor for acceptability of steaks. Steaks had a slight off-flavor on d 0 of retail display after 8 wk CAP storage and onwards. Considering the intrinsic variability in meat cuts, such slight deterioration of flavor and odor may be of no practical importance.

The relative success of the system used in the present study is noteworthy considering the poor color stability of PM muscle. The system is able to deliver longer CAP storage with longer subsequent retail display life if beef muscles with higher color stability are used. It can be conservatively concluded that the present system has the capability of providing a 10 week CAP storage life with a subsequent 3 day retail display life for centrally prepared beef tenderloin steaks.

### EXAMPLE 5

### Shelf Life Extension of Lamb Chops Utilizing Zero-Oxygen Tech.

Master-Packaging, Storage, and Sampling of Steaks

Fresh lamb primal cuts from animals slaughtered 2-3 h previously, were obtained from a lamb abattoir. Eighty chops of 2-cm thickness were prepared from these cuts. Each chop was placed on an absorbent pad and a foam tray, with O₂ scavengers placed underneath the absorbent pad. Each retail tray was over-wrapped with a shrinkable O₂ permeable film with an O₂ transmission rate of 8000 mL/(m²24 h) at 23° C., 70% R.H., and atmospheric pressure. After sealing, the film was shrunk to the tray using a hot-air gun. One 3-mm hole was made at the opposite corners of the tray. Four such retail trays were placed in a master pack with O₂ transmission-rate of 0.55 mL/(m²24 h) at 23° C, 70% R.H., and atmospheric pressure. The bags were evacuated, filled with 4.5 L of N₂ and sealed using a MAP machine (CVP systems International, Downers Grove, Ill.). Ten such bags were prepared. Similarly, ten such packages were prepared by using plastic trays instead of foam trays. During initial packaging, the O₂ concentration was measured in every fifth bag by using an O₂ analyzer (Mocon MS-750, Modern Controls Inc., Minneapolis, Minn.), which uses a solid state O₂ ion conduction material, zirconium oxide. The O₂ analyzer had an accuracy of ±5 ppm in the 0 to 1000-ppm range, ±0.05% in the 0.1 to 10% range, and ±1% in the 10 to 100% ranges for O₂ concentrations. The resolution of the analyzer was smaller than the accuracy; that is, in the 0 to 1000 ppm O₂ concentration range the resolution was 1 ppm.

The master packs were stored at −1.5° C. Two master packs (one containing foam trays and the other containing plastic trays) were opened at subsequent 1 wk storage intervals for 8 wk. The O₂ concentration in each bag was measured immediately before opening the bag.

Display and Sampling of Retail Trays

Upon removal from primary CAP storage at weekly intervals, and on day 0 of retail display, master packaging was removed and each group of 8 retail trays was placed for sensory analysis.

The displayed chops were examined for color, discoloration, retail-acceptability, off odor intensity, odor acceptability, and odor description, 20 min after opening of the master-packages. After visual and odor scores were obtained, two chops (one from each master bag) were removed from the display case, and samples were taken for microbial analysis. A similar procedure was repeated for all storage intervals.

Visual Assessment of Master-Packaged Lamb Chops

A three-four-member panel was used for the subjective evaluation of the steaks. Color scores were assessed using an eight point descriptive scale: 0=Completely discolored, 1=White, 2=Pale pink, 3=Pink, 4=Pale red, 5=Bright cherry red, 6=Slightly dark red, 7=Moderately dark red, 8=Extremely dark red. Surface discoloration was evaluated using a seven point descriptive scale: 1=0% (none), 2=1-10%, 3=11-25%, 4=26-50%, 5=51-75%, 6=76-99%, 7=100%. Retail appearance was assessed on a seven point hedonic scale: 1=Extremely undesirable, 2=Undesirable, 3=Slightly undesirable, 4=Neither desirable nor undesirable, 5=Slightly desirable, 6=Desirable, 7=Extremely desirable.

Odor Assessments of Master-Packaged Lamb Chops

A three-four-member panel was used for the odor assessment. off odor intensity scores were assessed using a four point descriptive scale: 1=No off odor, 2=Slight off odor, 3=Moderate off odor, 4=Prevalent off odor; odor acceptability scores were assessed using a five-point scale: 1=Acceptable, 2=Slightly acceptable, 3=Neither acceptable nor unacceptable, 4=Slightly unacceptable, 5=Unacceptable; and off odor description scores were assessed using a six-point scale: 1=Sour-sulfur (rotten eggs), 2=Sour-lactic acid, 3=Putrid, 4=Dirty socks, 5=Floral/Fruity, 6=Other.

Flavor Assessment of Master-Packaged Lamb Chops

Ken (General Manager, Grove Meats, Blue Island, Ill. Island) cooked the lamb chops after 27 and 55 days of storage for informal flavor assessment.

Microbial Assessment

Silliker Laboratories, Chicago, Ill., analyzed the lamb chops, after every weekly storage interval, for aerobic, anaerobic, E. coli, Listeria, and Salmonella.

Results

Oxygen Concentration

The oxygen concentrations in the master packages were in the range of 0.5% immediately after packaging which went up to 2-5% within few minutes of gas flushing and sealing. The oxygen concentration was reported to be Zero for each weekly storage interval.

Visual, Odor, Microbial and Flavor Assessment

The lamb chops had bright red to dark red color, zero to minimal discoloration, and extremely acceptable to acceptable, and no off-odor for all the storage and display time intervals (please refer to the attached graphs). The microbial load showed a gradual increase in the count, with no detrimental effect to the meat quality. Also, pathogen-growths were negative for all storage intervals (please refer to microbial growth graph. The flavor was assessed to be extremely acceptable after 27 days of storage.

Discussion

The lamb chops were extremely desirable for all storage intervals and display periods. The testing showed no difference between chops packaged in plastic ad foam trays with all having retail acceptability and no odor throughout the display period. Such results are already predicted by Dr. Tewari's hypothesis of Zero Oxygen System that is based upon preventing the metmyoglobin reducing activity of the muscle by zeroing the oxygen rapidly. This enhances the display life of centrally prepared retail ready meat cuts. In addition, nitrogen atmosphere provided anaerobic atmosphere, and helps in reblooming of the meat once removed from the master package. the testing further confirmed Dr. Tewari's concept of zero oxygen packaging system for centralized meat operations. A storage life of 8+ weeks with a subsequent display life of 4+ days was obtained for centrally prepared retail ready lamb chops by employing Dr. Tewari's Zero Oxygen System.

These Results Demonstrate the Following Principles:

1. Metmyoglobin reducing activity is capable of being restored provided the oxygen concentration in the master package which contains meat cuts is reduced to zero ppm within a few hours of sealing the package.

2. Oxygen absorption kinetics by an oxygen scavenger is bi-phasic where the rate of oxygen absorption varies with the initial oxygen concentration.

3. The oxygen scavengers are pre-treated by moisture for faster activation.

4. The oxygen scavengers based on an iron chemical system are utilized to reduce the oxygen concentration in the master bag

5. The calculation of half-life will be dependent upon the initial oxygen concentration in the package and the ambient temperature.

6. The permeability of packaging films having very high oxygen ingress rate is significantly reduced at sub-zero temperatures where the films act as an oxygen barrier.

Included within the scope of the present invention and the abovementioned examples are compositions comprising various combinations of these substances and materials. Aspects of the present invention have ben described by way of example only and it should be appreciated that modifications and additions may be made thereto without departing from the scope thereof.

### INDUSTRIAL APPLICABILITY

The present invention finds specific industrial applicability in the food distribution and retail industries.

APPENDIX A

### EXAMPLE 6

### Shelf Life Extension of Pork Chops by Employing “Zero Oxygen Packaging System”

Master Packaging, Storing, and Sampling of Steaks

Fresh pork loins from animals slaughtered 24 h previously, were obtained from a local beef abattoir. One hundred and twenty chops of 2 cm thickness, were prepared from these loins. Each chop was placed on a 152×114 mm absorbent pad in a 216×133×25 mm (L×W×H) solid polystyrene tray with six O₂ scavengers (based on iron chemical system; capacity >600 mL; half-life of O₂=0,5 h) placed underneath the chop. Each retail tray was over-wrapped with a shrinkable O₂ permeable film with an O₂ transmission rate of 800 mL/(m² 24 h) at 23° C., 70% R.H., and atmospheric pressure. After sealing, the film was shrunk to the tray using a hot-air gun. Then, two 3-mm holes were made at the opposite corners of the tray to allow free exchange of atmospheres during gas flushing. Four such retail trays were placed in an EVA co-extruded master pack with O₂ transmission-rate of 0.55 mL/(m² 24 h) at 23° C., 70% R.H., and atmospheric pressure. The bags were evacuated, filled with 4.5 L of N₂, and sealed using a CAP machine. Thirty such bags were prepared. Additionall, 8 retail trays ere prepared and treated as un-stored controls.

The master packs were stored at −1.5±0.5° C. On week 0 and d 0 or retail display, four steaks in retail trays, serving as fresh, un-stored controls, were analyzed for visual, odor, taste, and microbial characteristics. The visual analysis was done daily for 6 d. On d 6 of retail display, odor, taste, and microbial analyses were done in addition to visual examination.. Two master packs were opened at subsequent 1 wk storage intervals for 15 wk. The O₂ concentration in each bag was measured immmediately before opening the bag.

Display and Sampling of Retail Trays

Upon removal from primary CAP stroage at weekly intervals, and on day 0 or retail display, master packaging was removed and each group of 8 retail trays was placed in the center of the display shelf.

The displayed pork chops were examined for color, discoloration, retail-acceptability, off odor intensity, odor accepability, and odor description, 45 min after opening of the master-packages. After visual scores were obtained, two chops (one from each master bag) were removed from the display case, and samples were taken for microbial analysis. The remaining six chops were left in the display case, and were examined for visual characteristics at subsequent intervals of 24 h. and reflectance spectra at 12 h for 96 h. After 144 h of retail display, the chops were analyzed in a similar fashion as on day 0 or retail display. During sensory evaluation, the samples remained in the display case and the well-trained panelists made judgments independently. A similar procedure was repeated for all storage intervals.

Visual Assessment of Master-Packaged Chops

A five-member panel was used for the subjective evaluation of the steaks. Color scores were assessed using an five-point descriptive scale: 0=Completely discolored, 1=Extremely pale, 2=Pale, 3=Normal, 4=Dark, 5=Extremely dark. Surface discoloration was evaluated using a seven-point descriptive scale: 1=0% (none), 2=1-10%, 3=11-25%, 4=26-50%, 5=51-75%, 6=76-99%, 7=100%. Retail appearance was assessed on a seven-point hedonic scale: 1=Extremely undesirable, 2=Undesirable, 3=Slightly undesirable, 4=Neither desirable nor undesirable, 5=Slightly desirable, 6=Desirable, 7=Extremely desirable.

Odor Assessments of Master-Packaged Chops

A five-member panel was used for the odor assessment. Off odor intensity scores were assessed using a four-point descriptive scale: 1=No off odor, 2=Slight off odor, 3=Moderate off odor, 4=Prevalent off odor, odor acceptability scores were assessed using a five-point scale: 1=Acceptable, 2=Slightly acceptable, 3=Neither acceptable nor unacceptable, 4=Slightly unacceptable, 5=Unacceptable; and off odor description scores were assessee using a six-point scale: 1=Sour-sulfur (rotten eggs), 2=Sour-lactic acid, 3=Putrid, 4=Dirty socks, 5=Floral/Fruity, 6=other.

Microbial Analysis

A 10-cm2 sample was obtained at each sampling time (on d 0 and 4 of each storage interval) from each of the two chops using a sterile cork borer. Then, the sample was placed into a stomacher bag with 10 mL of 0.1% peptone solution and was massaged for 120 s using a commercial stomacher, yielding a dilution of 10⁰. The homogenate was further diluted 10-, 100-, 1000-, 10000-, and 100000-fold, after which 0.1 mL volumes of undiluted homogenate and of each dilution prepared, were spread on duplicate plates of APT (All Purpose Tween). The plates were incubated aerobically for 3 d at 25° C. The micro flora was determined from plates bearing 20-200 colonies.

Results

Measurement of O₂ Concentration

The O₂ concentration was <100 ppm at initial packaging, and after and CAP storage interval it was reduced to 0 ppm. The oxygen concentration was down to zero ppm within three hours of master pack closure.

Evaluation of Chops

Figures attached clearly indicate a storage life of at least 15 weeks and a retail display life of at least six days for pork chops packaged by employing “zero oxygen packaging systems approach”. It is interesting to note that the visual and microbial characteristics of the pork chops remained in an acceptable condition even after such a long storage in cooler and at retail display case.

APPENDIX B

[image]

### EXAMPLE 1

TABLE 1A
Half-life of O₂ in bags containing scavengers based upon enzymes and iron
chemical systems, and air or N₂ atmosphere.

| | | O₂ half-life (h) | | | |
|---|---|---|---|---|---|
| Scavenger-type | Atmosphere | 25° C. | 12° C. | 2° C. | −1.5° C. |
| Iron chemical system | Air | 0.6 (0.04)* | 0.7 (0.02) | 1.0 (0.03) | 2.5 (0.04) |
| (type 1) | N₂ + air | 1.3 (0.03) | 1.5 (0.04) | 2.2 (0.05) | 2.3 (0.05) |
| Enzyme system (type 1) | Air | 1.0 (0.03) | 1.6 (0.02) | 4.0 (0.02) | 7.1 (0.04) |
| | N₂ + air | 3.3 (0.02) | 7.1 (0.03) | 12.0 (0.03) | 8.4 (0.03) |
| Iron chemical system | Air | 0.6 (0.04) | — | 0.8 (0.05) | 0.8 (0.04) |
| (type 2) | N₂ + air | 0.9 (0.02) | — | 0.9 (0.04) | 1.3 (0.04) |
| Enzyme system (type 2) | Air | 1.6 (0.02) | — | — | — |
| | N₂ + air | 6.5 (0.06) | — | — | — |
| Iron chemical system | Air | 4.5 (0.08) | — | — | — |
| (type 1 in over-wrapped | N₂ + air | 5.0 (0.08) | — | — | — |
| tray) | | | | | |

*Standard deviation.
—An experiment was not performed under this condition.

TABLE 1B
Constants of first order kinetics equation for different scavengers.

| | | | | Constants of first order | | | |
|---|---|---|---|---|---|---|---|
| | Temp. | | | kinetics equation^{a} | | Calculated O₂ half- | Correlation |
| Scavenger-type | (° C.) | Atmosphere | Initial O₂ concentration (ppm) | k (h⁻¹) | A₀ | life^{b} (h) | coefficient (r²) |
| Iron chemical system | 25 | Air | 200,000 | 2.46 | 3.94 | 0.3 | 0.98 |
| (type 1) | 25 | N₂ + air | 500 | 0.35 | 0.51 | 1.8 | 0.92 |
| | 12 | Air | 200,000 | 1.82 | 3.96 | 0.4 | 0.96 |
| | 12 | N₂ + air | 500 | 0.36 | 0.61 | 1.9 | 0.98 |
| | 2 | Air | 200,000 | 0.69 | 3.61 | 1.0 | 0.99 |
| | 2 | N₂ + air | 500 | 0.25 | 0.79 | 2.7 | 0.99 |
| | −1.5 | Air | 200,000 | 0.31 | 3.54 | 2.3 | 0.92 |
| | −1.5 | N₂ + air | 500 | 0.26 | 0.76 | 2.7 | 0.99 |
| Enzyme (type 1) | 25 | Air | 200,000 | 0.56 | 3.34 | 1.2 | 0.99 |
| | 25 | N₂ + air | 500 | 0.20 | 0.88 | 3.5 | 0.99 |
| | 12 | Air | 200,000 | 0.40 | 3.62 | 1.7 | 0.99 |
| | 12 | N₂ + air | 500 | 0.09 | 0.84 | 7.7 | 0.99 |
| | 2 | Air | 200,000 | 0.20 | 3.45 | 3.5 | 0.99 |
| | 2 | N₂ + air | 500 | 0.06 | 0.80 | 11.5 | 0.96 |
| | −1.5 | Air | 200,000 | 0.08 | 3.72 | 8.7 | 0.98 |
| | −1.5 | N₂ + air | 500 | 0.08 | 0.84 | 8.7 | 0.99 |

^{a}1n[O₂]ₜ = −kt + A₀ = −kt + 1n[O₂]₀; [O₂]ₜ is volume (mL) of O₂ in the pack atmosphere at time t (hour) and [O₂]₀ is volume (mL) of O₂ in the pack atmosphere at t = 0 h.
^{b}Calculated half-life (h) = 0.693/k; observed half-life in Table 1.

### EXAMPLE 2

TABLE 2a
Description of treatments for beef steaks and pork chops
for experiment 1.

| Treatment | N^{a} | Description |
|---|---|---|
| A | 3 | Lidded control tray with meat |
| B | 3 | Lidded tray containing meat and grid |
| C | 3 | Lidded tray with meat and absorbent pad |
| D | 3 | Lidded tray containing meat and O₂ scavengers inside the |
| | | retail tray |
| E | 3 | Lidded tray containing meat, grid, and absorbent pad |
| F | 3 | Lidded tray containing meat, grid. and O₂ scavengers |
| | | inside the retail tray |
| G | 3 | Lidded tray containing meat, absorbent pad, and O₂ |
| | | scavengers inside the retail tray |
| H | 3 | Lidded tray with meat, grid, absorbent pad, and O₂ |
| | | scavengers inside the retail tray |
| D1 | 3 | Treatment D with O₂ scavengers outside the retail tray |
| F1 | 3 | Treatment F with O₂ scavengers outside the retail tray |
| G1 | 3 | Treatment G with O₂ scavengers outside the retail tray |
| H1 | 3 | Treatment H with O₂ scavengers outside the retail tray |

^{a}Number of retail trays in a master pack.

TABLE 2b
Oxygen (O₂) concentration in master packs containing beef and pork
stored at 2° C. in 100% nitrogen (N₂) atmosphere for seven days.

O₂ Concentration (ppm)

| Treatment | Beef | Pork |
|---|---|---|
| During initial packaging | 150-200 | 150-200 |
| A | 214 | 853 |
| B | 334 | 1150 |
| C | 890 | 862 |
| D⁺ | 0 | 0 |
| E | 201 | 377 |
| F⁺ | 0 | 0 |
| G⁺ | 30 | 0 |
| H⁺ | 1560 | 0 |
| D1x | 0 | 0 |
| F1x | 0 | 0 |
| G1x | 102 | 0 |
| H1x | 0 | 0 |

⁺O₂ scavengers inside the retail tray
xO₂ scavengers outside the retail tray

TABLE 2c
Mean colour, surface discoloration, and retail appearance scores and standard errors for pork chops and beef steaks
after various treatments.

| | Beef | | | | | | Pork | | | | | |
|---|---|---|---|---|---|---|---|---|---|---|---|---|
| Treatment | Color^{†,+} | SE⁺⁺ | Discoloration^{††,+} | SE | Retail Appearance^{‡,+} | SE | Color^{†,+} | SE⁺⁺ | Discoloration^{††,+} | SE | Retail Appearance^{‡,+} | SE |
| A | 6.75^{A} | 0.22 | 5.58^{A} | 0.69 | 2.00^{E} | 0.42 | 2.75^{D} | 0.22 | 3.83^{A} | 0.74 | 3.67^{E} | 0.75 |
| B | 5.50^{B,C} | 0.26 | 5.50^{A,B} | 0.40 | 1.92^{E} | 0.45 | 2.75^{D} | 0.22 | 3.33^{A,B} | 0.68 | 4.58^{D} | 0.72 |
| C | 5.00^{D,C} | 0.00 | 5.17^{A,B} | 0.20 | 2.25^{E} | 0.44 | 3.00^{B,C} | 0.00 | 1.25^{C} | 0.22 | 6.75^{A,B} | 0.22 |
| D⁺⁺⁺ | 5/20^{D,C} | 0.20 | 1.00^{E} | 0.00 | 6.25^{A} | 0.22 | 3.00^{B,C} | 0.00 | 1.00^{C} | 0.00 | 6.75^{A,B} | 0.22 |
| E | 5.75^{E} | 0.25 | 4.67^{B} | 0.39 | 1.92^{E} | 0.34 | 3.25^{A} | 0.22 | 1.00^{C} | 0.00 | 6.50^{A,B} | 0.26 |
| F⁺⁺⁺ | 5.00^{D,C} | 0.09 | 1.67^{D,E} | 0.39 | 6.25^{A} | 0.44 | 3.08^{A,B} | 0.15 | 1.17^{C} | 0.20 | 6.60^{A,B} | 0.26 |
| G⁺⁺⁺ | 5.00^{D,C} | 0.30 | 1.83^{D,E} | 0.56 | 4.75^{C} | 0.57 | 2.83^{D,C} | 0.20 | 1.42^{C} | 0.25 | 6.33^{B} | 0.25 |
| H⁺⁺⁺ | 6.00^{A,B} | 0.06 | 3.50^{H} | 0.45 | 3.25^{D} | 0.38 | 3.00^{B,C} | 0.00 | 1.17^{C} | 0.20 | 6.83^{A,B} | 0.20 |
| D1^{x} | 5.58^{A,B} | 0.10 | 1.81^{D,E} | 0.62 | 5.00^{B,A,C} | 0.62 | 2.36^{E} | 0.26 | 2.47^{B} | 0.94 | 5.23^{C} | 0.26 |
| F1^{x} | 5.67^{B,C} | 0.32 | 1.92^{D} | 0.86 | 5.08^{B,C} | 0.58 | 3.00^{B,C} | 0.00 | 1.00^{C} | 0.00 | 7.00^{A} | 0.00 |
| G1^{x} | 5.58^{D} | 0.29 | 5.83^{A} | 0.47 | 1.83^{E} | 0.36 | 3.00^{B,C} | 0.00 | 1.08^{C} | 0.15 | 6.92^{A} | 0.15 |
| H1^{x} | 5.67^{B,C} | 0.25 | 1.58^{D,E} | 0.34 | 5.75^{A,B} | 0.38 | 3.00^{B,C} | 0.00 | 1.08^{C} | 0.15 | 6.92^{A} | 0.15 |

^{†}Color scale (pork chop): 0 = Completely discolored, 1 = Extremely pale, 2 = Pale, 3 = Normal, 4 = Dark, 5 = Extremely dark; Color scale (beef steak): 0 = Completely discolored, 1 = White, 2 = Pale pink, 3 = Pink, 4 = Pale red, 5 = Bright cherry red, 6 = Slightly dark red, 7 = Moderately dark red, 8 = Extremely dark red.
^{††}Discoloration scale (pork chop or beef steak): 1 = 0% (none), 2 = 1-10%, 3 = 11-25%, 4 = 26-50%, 5 = 51-75%, 6 = 76-99%, 7 = 100% (complete).
^{‡}Retail appearance scale (pork chop or beef steak): 1 = Extremely undesirable, 2 = Undesirable, 3 = Slightly undesirable, 4 = Neither desirable nor undesirable, 5 = Slightly desirable, 6 = Desirable, 7 = Extremely desirable.
⁺Means in the same colunm bearing a common letter do not differ significantly (p > 0.05).
⁺⁺Standard errors of difference.
⁺⁺⁺O₂ scavengers inside the retail tray.
^{x}O₂ scavengers outside the retail tray.

TABLE 2d
Mean values of the chemical states of myoglobin (% met-, % deoxy-, and % oxy-myoglobin) and
standard errors of difference for pork chops and beef steaks after various treatments.

| | Pork | | | | | | Beef | | | | | |
|---|---|---|---|---|---|---|---|---|---|---|---|---|
| | % of chemical states of myoglobin | | | | | | % of chemical states of myoglobin | | | | | |
| [symbol] atment | % met-⁺ | SE⁺⁺ | % deoxy-⁺ | SE | % oxy-^{†,+} | SE | % met | SE | % deoxy | SE | % oxy | SE |
| [symbol] | 26.81^{A} | 5.80 | 24.18^{D,C} | 5.07 | 49.01^{F,E} | 0.72 | 57.43^{A} | 6.07 | 0.00^{B} | 0.00 | 42.57^{D,C} | ^{6.07} |
| [symbol] | 20.37^{A} | 8.80 | 24.62^{D,C} | 4.07 | 55.01^{F,D,E,C} | 4.79 | 55.24^{A} | 24.16 | 4.12^{A,B} | 1.80 | 40.64^{D} | 23.35 |
| [symbol] | 5.22^{B} | 0.94 | 42.10^{A,B} | 3.02 | 52.68^{F,D,E} | 2.16 | 23.23^{B,A,C} | 16.36 | 1.36^{B} | 0.65 | 75.41^{B,D,A,C} | 16.93 |
| [symbol] ⁺ | 0.01^{B} | 0.01 | 37.77^{B,A,C} | 3.84 | 62.22^{B,D,E,C} | 3.85 | 0.58^{C} | 0.05 | 3.04^{A,B} | 1.40 | 96.38^{A,B} | 0.95 |
| [symbol] | 5.44^{B} | 2.40 | 47.90^{A} | 3.00 | 46.66^{F} | 1.70 | 17.74^{B,C} | 15.36 | 2.06^{B} | 1.58 | 80.20^{B,A,C} | 14.53 |
| [symbol] ⁺ | 0.14^{B} | 0.10 | 35.34^{B,D,A,C} | 4.35 | 64.52^{B,D,A,C} | 4.45 | 0.00^{C} | 0.00 | 1.21^{B} | 1.05 | 98.79^{A} | 1.05 |
| [symbol] ⁺ | 2.07^{B} | 1.80 | 21.83^{D} | 7.50 | 76.10^{A,B} | 8.22 | 2.11^{B,C} | 1.82 | 5.67^{A,B} | 2.92 | 92.22^{A,B} | 1.62 |
| [symbol] ⁺ | 0.00^{B} | 0.00 | 31.95^{B,D,A,C} | 3.38 | 68.05^{B,A,C} | 3.38 | 7.83^{B,C} | 4.46 | 13.71^{A} | 8.80 | 78.46^{B,A,C} | 8.03 |
| [symbol] ^{x} | 0.00^{B} | 0.00 | 21.07^{D} | 2.35 | 78.93^{A} | 2.35 | 2.40^{B,C} | 1.07 | 7.12^{A,B} | 1.00 | 90.48^{A,B} | 0.15 |
| [symbol] ^{x} | 0.00^{B} | 0.00 | 28.74^{B,D,C} | 4.67 | 71.26^{A,B} | 4.16 | 2.24^{B,C} | 1.80 | 5.20^{A,B} | 4.45 | 92.56^{A,B} | 3.79 |
| [symbol] ^{x} | 0.00^{B} | 0.00 | 25.56^{D,C} | 3.32 | 74.44^{A,B} | 3.32 | 37.29^{A,B} | 16.24 | 3.78^{A,B} | 1.48 | 58.93^{B,D.C} | 17.71 |
| [symbol] ^{x} | 6.82^{B} | 5.90 | 27.83^{B,D,C} | 7.27 | 65.36^{B,D,A,C} | 3.78 | 0.00^{C} | 0.00 | 8.53^{A,B} | 4.23 | 91.47^{A,B} | 4.23 |

^{†}% oxy- = 100-[(% met-) + (% deoxy-)]
⁺Means in the same column bearing a common letter do not differ significantly (p > 0.05).
⁺⁺Standard errors of difference.
⁺⁺⁺O₂ scavengers inside the retail tray.
^{x}O₂ scavengers outside the retail tray.

What is claimed and desired to be secured by Letters Patent is as follows:

1. A packaging system adapted to extend shelf-life of meat comprising:
a tray having an activated oxygen scavenger and an absorbent pad; and
a master bag being back-flushed with nitrogen gas and housing said tray therein.

2. The packaging system as recited in claim 1, wherein said oxygen scavenger is based upon an iron chemical system.

3. The packaging system as recited in claim 1, wherein said master bag is filled with 100% of said nitrogen gas.

4. The packaging system as recited in claim 1, wherein said master bag is capable of housing multiple trays therein.

5. The packaging system as recited in claim 2, wherein said oxygen scavenger having an optimal capacity of at least 600 mL.

6. The packaging system as recited in claim 5, wherein said optimal capacity resulting in having a half-life of oxygen in the range of 0.6-2 h.

7. The packaging system as recited in claim 1, wherein said packaging system has at least a ten week storage life.

8. The packaging system as recited in claim 7, wherein said packaging system further comprises a display life of at least three days.

9. The packaging system as recited in claim 1, wherein said master bag is a gas-impermeable bag.

10. The packaging system as recited in claim 1, further comprising a permeable film operatively surrounding said tray.

11. The packaging system as recited in claim 10, wherein said film has a high oxygen permeability.

12. The packaging system as recited in claim 2, wherein said iron chemical system is a chemical selected from the group consisting of ferrous iron, ferric oxide and ferric hydroxide.

13. The packaging system as recited in claim 1, wherein said oxygen scavenger is positioned underneath said absorbent pad.

14. The packaging system as recited in claim 1, wherein said oxygen scavenger is placed underneath a meat cut.

15. A method of extending shelf-life of meat comprising the steps of:
placing at least one cut of meat onto a tray having an activated oxygen scavenger and an absorbent pad;
arranging and sealing a permeable film over said tray thereby housing said cut of meat therein;
filling a master bag with nitrogen gas
inserting at least one of said trays into said master bag; and
sealing said master bag into a closed position.

16. The method as recited in claim 15, wherein said activated oxygen scavenger and absorbent pad is positioned underneath said cut of meat.

17. The method as recited in claim 15, wherein said cut of meat is selected from the group consisting of lamb, beef and pork.

18. The method as recited in claim 17, wherein said lamb and beef has a shelf-life of up to ten weeks.

19. The method as recited in claim 17, wherein said pork has a shelf-life of up to fifteen weeks.

20. The method as recited in claim 15, further comprising the step of:
placing said master bag into a cooler for a determined period of time.
